(19) United States
(12) Patent Application Publication
(10) Pub. No.: US 2025/0243297 A1
(43) Pub. Date: Jul. 31, 2025

(54) NANOHYBRID CHITOSAN COMPOSITE-BASED CORROSION INHIBITOR

(71) Applicant: Imam Abdulrahman Bin Faisal University, Dammam (SA)

(72) Inventors: Asma Mohammed Zamil ELSHARIF, Dammam (SA); Shamsudeen Abdullahi HALADU, Dammam (SA); Renad Abdulrazaq AL YAMI, Dammam (SA)

(73) Assignee: Imam Abdulrahman Bin Faisal University, Dammam (SA)

(21) Appl. No.: 18/423,681

(22) Filed: Jan. 26, 2024

(51) Int. Cl. C08B 37/08; C08J 5/00; C23F 11/06

(52) U.S. Cl. CPC C08B 37/003; C08J 5/005; C23F 11/06; C08J 2305/08

(57) ABSTRACT

A nanohybrid chitosan (NHc) composite includes a matrix of a chitosan Schiff base of Formula (I), and a plurality of spherical silver nanoparticles (AgNPs) uniformly distributed throughout the matrix of the chitosan Schiff base. The NHc composite has a porous structure containing a plurality of interconnected pores. A method for inhibiting corrosion of a metal article.

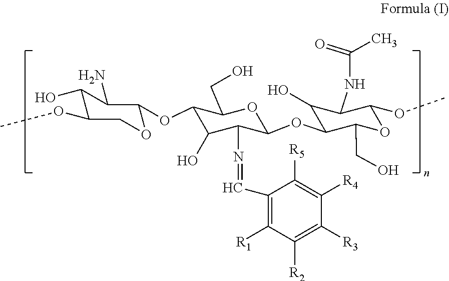

### BACKGROUND

### Technical Field

The present disclosure is directed to corrosion inhibitors, more particularly to a chitosan protonated Schiff base derivative as a green corrosion inhibitor.

### Description of Related Art

The “background” description provided herein is to present the context of the disclosure generally. Work of the presently named inventors, to the extent it is described in this background section, as well as aspects of the description that may not otherwise qualify as prior art at the time of filing, are neither expressly nor impliedly admitted as prior art against the present invention.

Today's chemical industries heavily rely on iron and its alloys to build various application materials. Due to the availability and suitability of mild steel, it has been used in many industries, such as the petroleum, where it is employed in acid descaling, chemical purification, and oil rig acidifying processes. While mild steel is a preferred material across many industries, it poses economic and technical challenges. Specifically, when utilized to remove mill scales from metal surfaces in chemical plants, major insufficient erosion corrosion is encountered.

In many countries, the economic aspect stands out as a crucial factor in addressing and mitigating corrosion. For instance, it is reported that the United States government and industry have incurred losses of almost USD 276 billion, equivalent to 3.1% of GDP due to corrosion. Furthermore, corrosion studies have also been conducted globally, including in Australia, England, Japan, and other regions. Nearly every country invests approximately 3-4% of its GDP in corrosion control, with corrosion losses averaging around 25-30% (See: Revie, R. W. (2008). Corrosion and corrosion control: an introduction to corrosion science and engineering. John Wiley & Sons). On the one hand, the incorporation of polymers and certain solutions may have reduced the corrosion rate. On the other hand, the implementation of new measures aimed at combating global warming and climate change has led to a swift escalation in corrosion costs. Therefore, corrosion stands out as a pervasive issue that remains to be addressed with emerging scientific knowledge.

Mild steel, acclaimed for its mechanical strength at a reasonable cost, is extensively utilized as one of the primary construction materials in the petroleum industry. However, it is highly susceptible to acidic conditions, particularly those involving chloride ions. These conditions may contribute to the breakdown of metal, resulting in a shortened useful life, increased expenses, and diminished profits (See: Daniyan, A. A., Unoru, L. E., Fayoni, 0. S. I., & Popoola, A. P. I. (2018). Structural evolution, optoelectrical and corrosion properties of electrodeposited WO₃ integration on Zn-TiO₂ electrolyte for defence super application).

Moreover, the deterioration of a material usually occurs in an electrochemical reaction. Oxidation and reduction processes, constituting the two types of electrochemical reactions, take place simultaneously within metals. The mechanism of electrochemical corrosion on mild steel is shown in FIG. 1A. Corrosion leads to the dissolution of metals into an ionic form on the anodic side of the reaction, while electrons enter the metal at the cathode, as depicted in FIG. 1A. The equations below represent the reactions at the anode and cathode during iron corrosion.

### Anodic Reaction:

$$Fe = {Fe}^{2 +} + 2 {e}^{-}$$

### Cathodic Reaction:

$$\begin{matrix}{O}_{2} + 4 {H}^{+} + 4 e -= 2 {H}_{2} O , and \\ 2 {H}^{+} + 2 {e}^{-} = {H}_{2}\end{matrix}$$

Consequently, corrosion has attracted considerable interest, prompting both academic institutions and industrial organizations to invest extensively in enhancing corrosion resistance. Strategies exist to minimize the corrosion of metal surfaces, with corrosion inhibitors being adopted by researchers due to their cost-effectiveness and ease of application (See: Rabizadeh, T., & Khameneh Asl, S. (2019). Chitosan as a green inhibitor for mild steel corrosion: Thermodynamic and electrochemical evaluations. Materials and Corrosion, 70(4), 738-748 and Zhang, K., Yang, W., Xu, B., Chen, Y., Yin, X., Liu, Y., & Zuo, H. (2018). Inhibitory effect of konjac glucomanan on pitting corrosion of AA5052 aluminium alloy in NaCl solution. Journal of colloid and interface science, 517, 52-60).

Organic molecules containing O, N, and S components in their complex molecular structure may serve as corrosion inhibitors. Examples include azoles, Schiff base, pyridine derivatives, pyrazole derivatives, and bipyrazole derivatives. Moreover, these substances may form a layer of molecules adsorbed on the metal surface, acting as a barrier against the metal's dissolution in the electrolyte. Their performance may also be influenced by their molecular structure, chemical composition, and attraction to the metal surface. Hence, the inhibition efficiency of these compounds depends primarily on functional groups, the presence of heteroatoms, aromatic rings, multiple bonds with π electrons, and electronic density (See: Jacob, K. S., & Parameswaran, G. (2010). Corrosion inhibition of mild steel in hydrochloric acid solution by Schiff base furoin thiosemicarbazone and Shahabi, S., Hamidi, S., Ghasemi, J. B., Norouzi, P., & Shakeri, A. (2019). Synthesis, experimental, quantum chemical and molecular dynamics study of carbon steel corrosion inhibition effect of two Schiff bases in HCl solution. Journal of Molecular Liquids).

Schiff base compounds have garnered recent attention as corrosion inhibitors for various metals, including aluminum, steel, and copper in acidic conditions (See: Murnu, L., Saha, S. K., Murmu, N. C., & Banerjee, P. (2019). Effect of stereochemical conformation into the corrosion inhibitive behaviour of double azomethine based Schiff bases on mild steel surface in 1 mol L⁻¹ HCl medium: An experimental, density functional theory and molecular dynamics simulation study). Chitosan is a polymer, and it is naturally found in many naval organisms, such as the crust and shells of crabs and lobster. Chitosan may have metal-inhibiting capabilities in acidic media (See: Fekrv, A. L., & Mohamed, R. R. (2010). Acetyl thiourea chitosan as an eco-friendly inhibitor for mild steel in sulphuric acid medium). Moreover, chitosan has undergone several derivatization processes to introduce more functionalities, aiming to enhance its effectiveness as an inhibitor.

However, these derivatization processes are time-consuming, requiring the use of extensive, volatile solvents, and hazardous chemicals. The effectiveness of organic compounds' in suppressing corrosion may be further improved through the utilization of halide ions in general and iodide ions specifically (See: Solomon, M. L., & Umoren, S. A. (2015). Enhanced corrosion inhibition effect of polypropylene glycol in the presence of iodide ions at mild steel/sulphuric acid interface). Chitosan finds applications in different industries, including the medical and pharmaceutical sectors for orthopaedic tissue engineering and water purification to eliminate heavy metals from polluted water. Moreover, because of specific qualities like strong film-forming ability, it is a candidate for use as a protective coating against corrosion on metal substrates (See: Abrishami, S., Naderi, R., & Ramezanzadeh, B. (2018). Fabrication and characterization of zinc acetylacetonate/Urtica Dioica leaves extract complex as an effective organic/inorganic hybrid corrosion inhibitive pigment for mild steel protection in chloride solution). Recent research has unveiled corrosion inhibitor applications of chitosan with both organic and inorganic compounds. The organic compounds of chitosan, known as green inhibitors, are adsorbed onto metallic surfaces. In contrast, the inorganic compounds of chitosan have a negative impact on the environment due to the release of toxins (See: Singh, A., Talha, M., X u, X., Sun, Z., & Lin, Y. (2017). Heterocyclic corrosion inhibitors for J55 steel in a sweet corrosive medium).

Although a few organic derivatives of chitosan have been used in the past as corrosion inhibitors, each of them suffers from one or more drawbacks hindering their adoption. Hence, there is a need to develop a corrosion inhibitor that may overcome or reduce the limitations above.

In view of the foregoing, it is one objective of the present disclosure to provide a nanohybrid chitosan (NHc) composite as a green corrosion inhibitor for corrosion inhibition. A second objective of the present disclosure is to provide a method for inhibiting corrosion of a metal article in contact with a corrosive medium comprising an acid. The method for inhibiting corrosion of a metal article further includes a step of preparing the NHc composite.

### SUMMARY

In an exemplary embodiment, a nanohybrid chitosan (NHc) composite is disclosed. The NHc composite includes a matrix of a chitosan Schiff base having a formula (I) as shown:

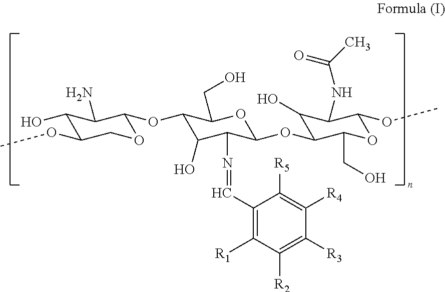

In some embodiments, R₁, R₂, R₃, R₄, and R₅ are each independently selected from the group consisting of a hydrogen atom, an optionally substituted alkyl, an optionally substituted cycloalkyl, an optionally substituted alkoxy, a hydroxyl group, a halogen group, an amine group, a nitro group, and a cyano group.

In some embodiments, n is an integer from 2 to 500.

In some embodiments, the NHc composite further includes a plurality of spherical silver nanoparticles (AgNPs) uniformly distributed throughout the matrix of the chitosan Schiff base.

In some embodiments, the NHc composite has a porous structure comprising a plurality of interconnected pores.

In some embodiments, the AgNPs have an average particle size of 5 nanometers (nm) to 50 nm.

In some embodiments, the chitosan Schiff base has a formula (II), as shown:

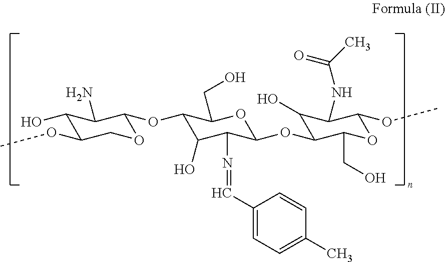

In some embodiments, the AgNPs interact with the matrix of the chitosan Schiff base derivative via an oxygen atom of a plurality of hydroxyl groups to form the NHc composite.

In some embodiments, the AgNPs interact with the matrix of the chitosan Schiff base via a nitrogen atom of a plurality of amino groups to form the NHc composite.

In some embodiments, the NHc composite has an average pore size of about 30 nm to 80 nm.

In some embodiments, the NHc composite includes about 71 weight percentage (wt. %) to 81 wt. % carbon, about 2 wt. % to 8 wt. % nitrogen, about 13 wt. % to 23 wt. % oxygen, about 0.1 wt. % to 1 wt. % sodium, and about 0.01 wt. % to 0.5 wt. % silver, each wt. % based on a total weight of the NHc composite, as determined by energy dispersive X-ray spectroscopy (EDX).

In some embodiments, the NHc composite includes about 76.08 wt. % carbon, about 4.75 wt. % nitrogen, about 18.68 wt. % oxygen, about 0.34 wt. % sodium, and about 0.15 wt. % silver, each wt. % based on a total weight of the NHc composite, as determined EDX.

In another exemplary embodiment, a method for inhibiting the corrosion of a metal article in contact with a corrosive medium, including an acid, is disclosed. The method includes immersing the metal article in the corrosive medium and introducing the aforementioned NHc composite into the corrosive medium in contact with the metal article, thereby adsorbing the NHc composite onto the surface of the metal article. In some embodiments, the NHc composite is present in the corrosive medium in an amount of 1 parts per million (ppm) to 1000 ppm based on a total number of parts of the corrosive medium.

In some embodiments, the metal article is made of at least one metal selected from the group consisting of a carbon steel, a carbon steel alloy, and a mild steel.

In some embodiments, the metal article is part of a casing, a pipe, a pump, a screen, a valve, or a fitting of an oil or gas well.

In some embodiments, the acid is at least one selected from the group consisting of hydrochloric acid (HCl), sulfuric acid (H₂SO₄), nitric acid (HNO₃), phosphoric acid (H₃PO₄), acetic acid, and hydrofluoric acid (HF).

In some embodiments, the metal article has a metal corrosion rate of about 0.916 millimeter penetration per year (mmpy) when the NHc composite is present in the corrosive medium in an amount of about 100 ppm based on a total number of parts of the corrosive medium.

In some embodiments, the aforementioned method has an inhibition efficiency of about 95.44% when the NHc composite is present in the corrosive medium in an amount of about 100 ppm based on a total number of parts of the corrosive medium.

In an exemplary embodiment, a method of preparing the NHc composite is described. The method includes mixing and refluxing chitosan, an aromatic aldehyde, and water in the presence of acetic acid to form the chitosan Schiff base in the form of a precipitate; mixing the chitosan Schiff base, the acetic acid and water to form a mixture; and dropwise adding a dispersion containing the plurality of AgNP₃ to the mixture and mixing.

In some embodiments, the aromatic aldehyde is p-tolualdehyde.

In some embodiments, a molar ratio of the chitosan to the aromatic aldehyde present in the mixture is about 1:1 to 1:20.

In some embodiments, the chitosan Schiff base is present in the mixture at a concentration of 0.002 grams per milliliter (g/ml) to 0.02 g/ml based a total volume of the mixture.

In some embodiments, the AgNP₃ are present in the dispersion at a concentration of 0.005 milligrams per milliliter (mg/ml) to 0.05 mg/ml based a total volume of the dispersion.

The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is a schematic illustration depicting electrochemical corrosion, according to certain embodiments;

FIG. 1B depicts a flowchart of a method for inhibiting corrosion of a metal article in contact with a corrosive medium, according to certain embodiments;

FIG. 1C depicts a flowchart of a method for preparing a nanohybrid chitosan (NHc) composite (p-tolualdehyde-chitosan silver nanospheres (AgNPs)), according to certain embodiments;

FIG. 2A is a schematic illustration depicting the synthesis of para (p)-tolualdehyde-chitosan Schiff base derivative (chitosan derivative), according to certain embodiments;

FIG. 2B depicts an experimental setup for the preparation of the chitosan derivative, according to certain embodiments;

FIG. 3 depicts Fourier transform infrared spectroscopy (FTIR) spectra of the chitosan derivative, according to certain embodiments;

FIG. 4A depicts hydrogen nuclear magnetic resonance (¹H NMR) spectra of the chitosan derivative, according to certain embodiments;

FIG. 4B depicts carbon nuclear magnetic resonance (¹³C NMR) spectra of the chitosan derivative, according to certain embodiments;

FIG. 5A is a schematic illustration depicting the synthesis of the NHc composite, according to certain embodiments;

FIG. 5B depicts an experimental setup for the preparation of silver nanohybrid derivative, according to certain embodiments;

FIG. 6 depicts FTIR spectra of AgNPs and the NHc composite, according to certain embodiments;

FIG. 7 depicts ultraviolet (UV) visible (UV-Vis) spectra of the AgNPs and the NHc composite, according to certain embodiments;

FIG. 8A depicts a scanning electron microscopy (SEM) micrograph of the AgNPs at 500 micrometer (μm) magnification, according to certain embodiments;

FIG. 8B depicts an SEM micrograph of the AgNPs at 1 μm magnification, according to certain embodiments;

FIG. 8C depicts an SEM micrograph of the AgNPs at 2 μm magnification, according to certain embodiments;

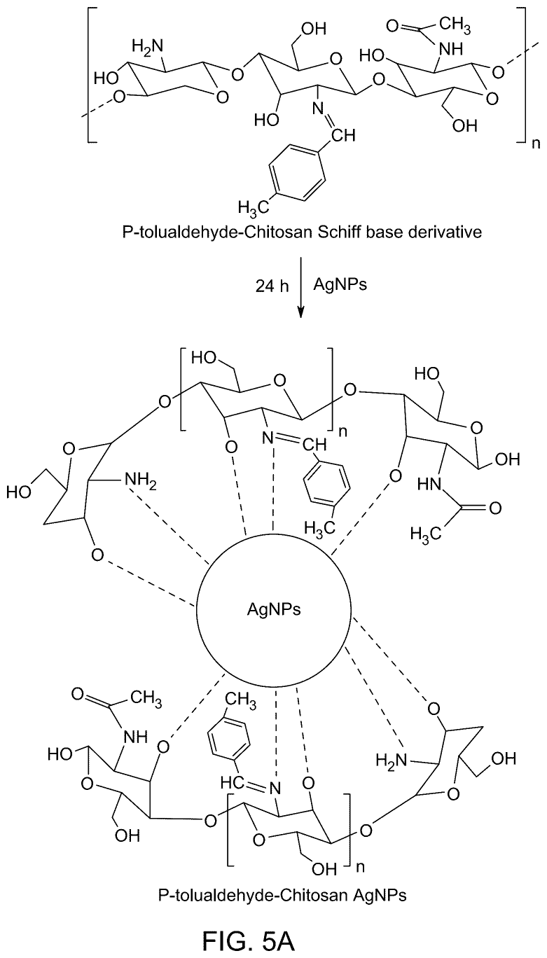

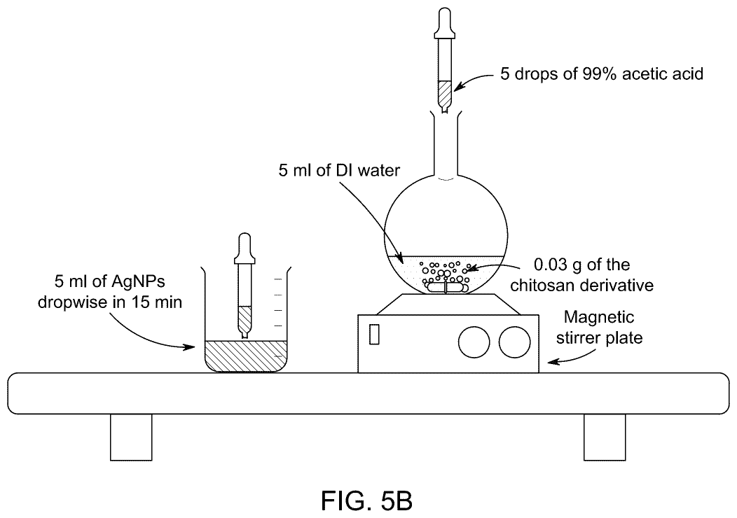

FIG. 5D depicts an SEM micrograph of the AgNPs at 5 μm magnification, according to certain embodiments;

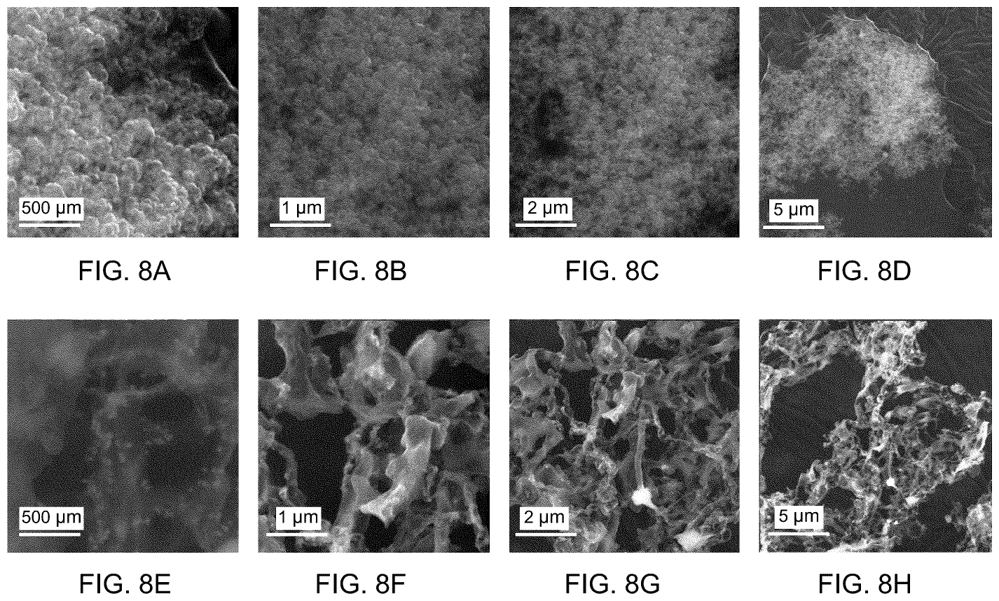

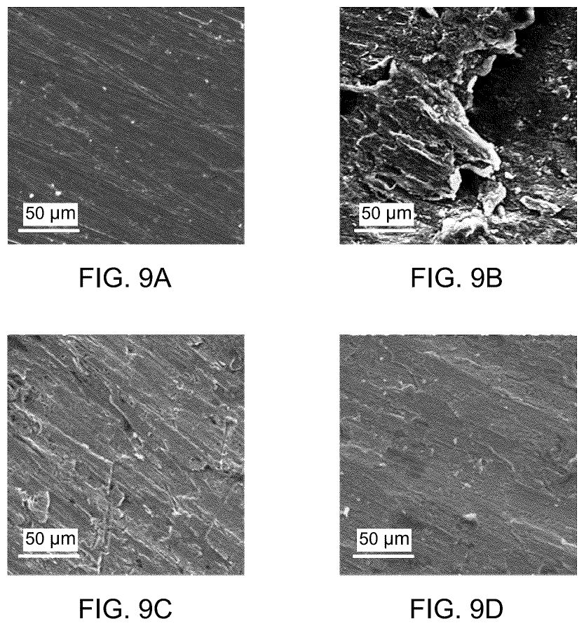

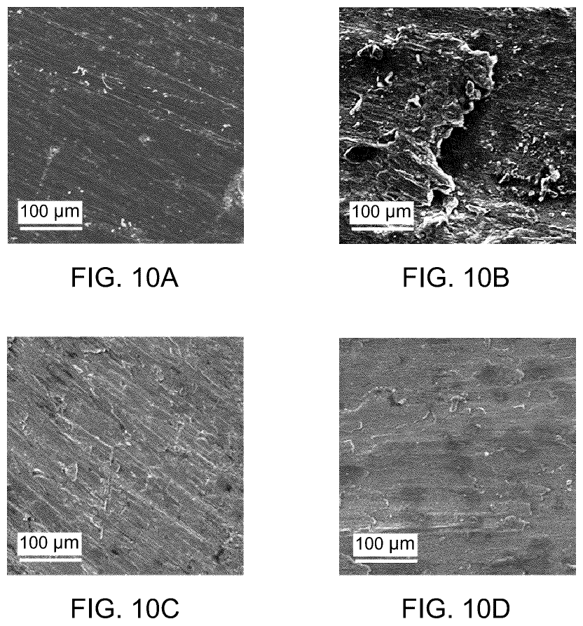

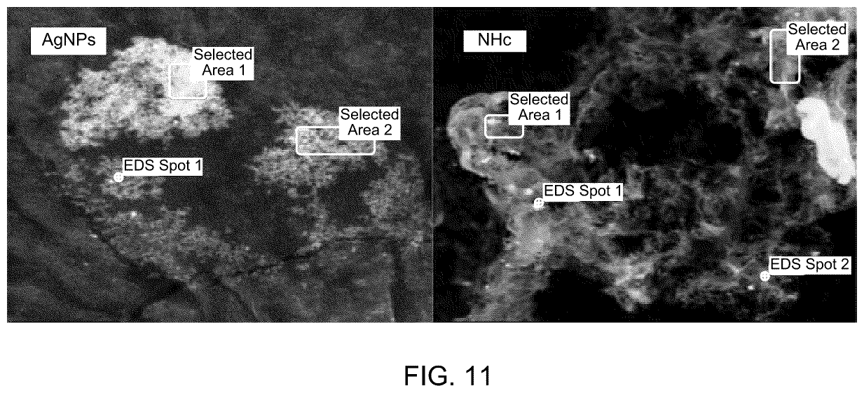

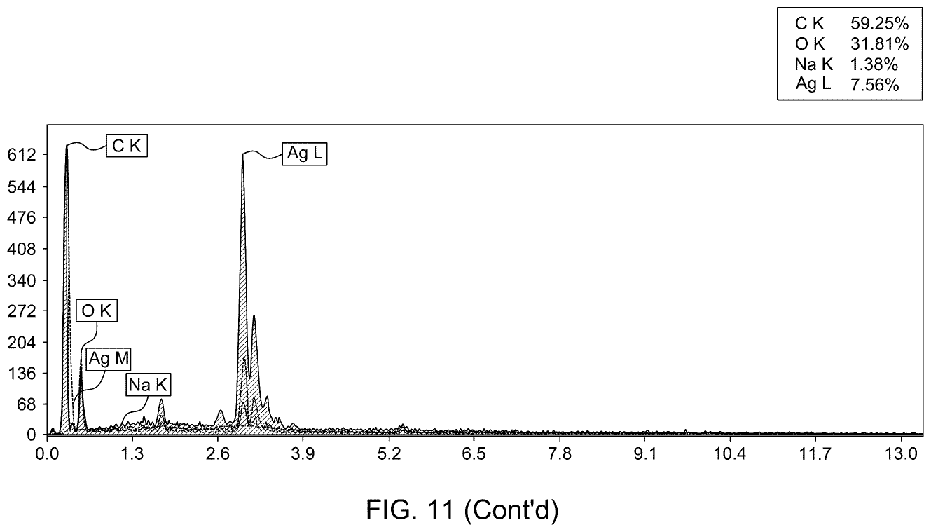

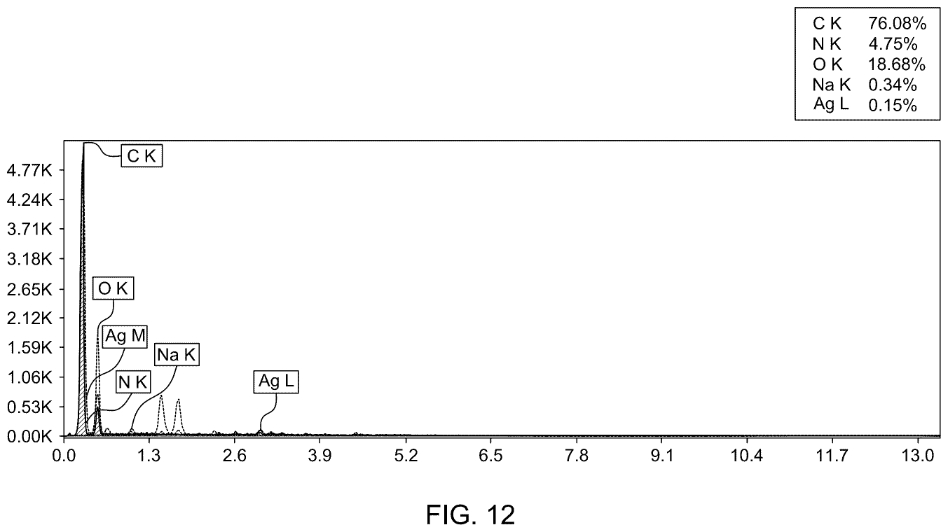

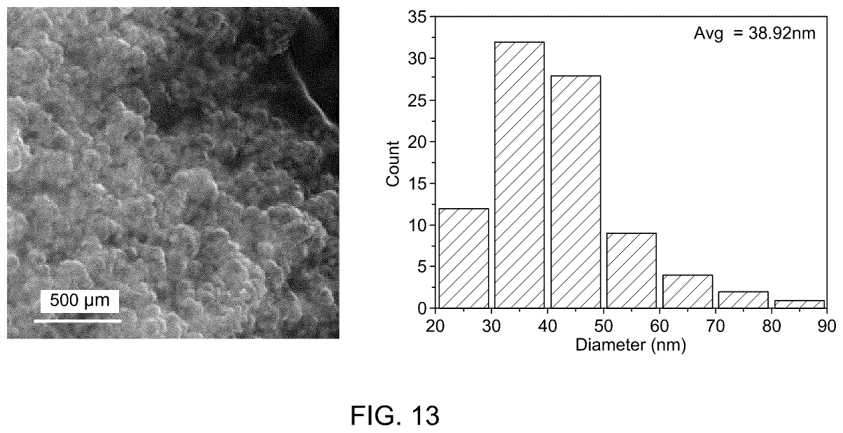

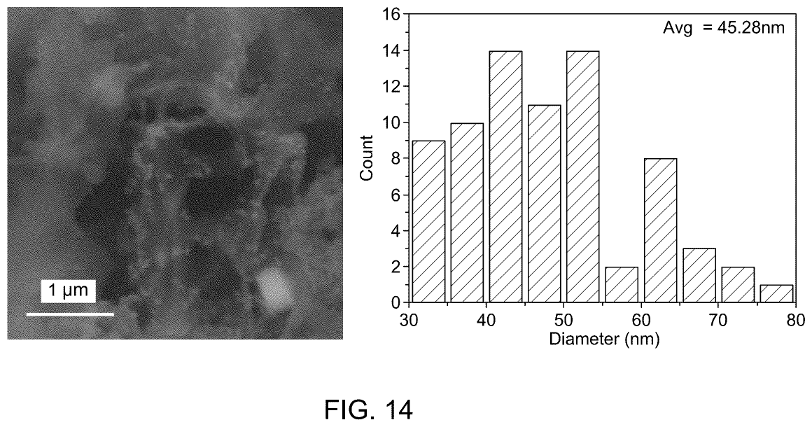

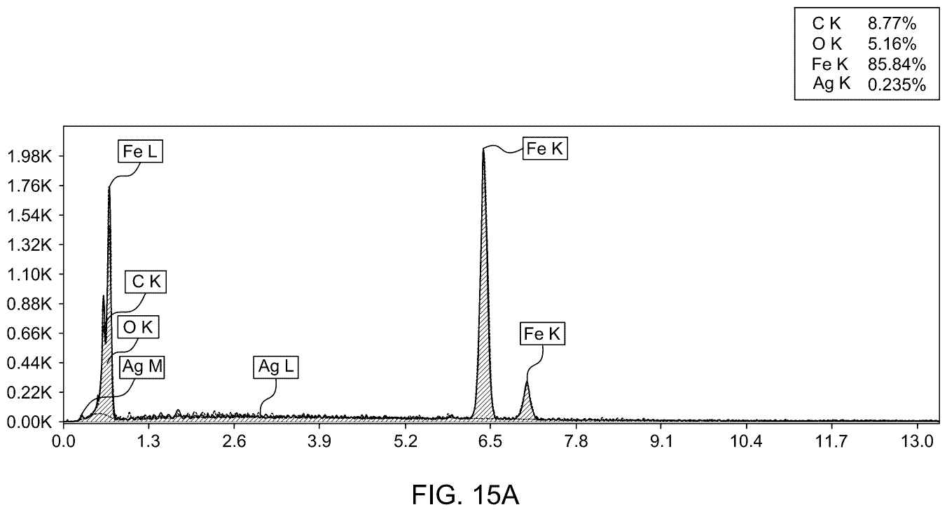

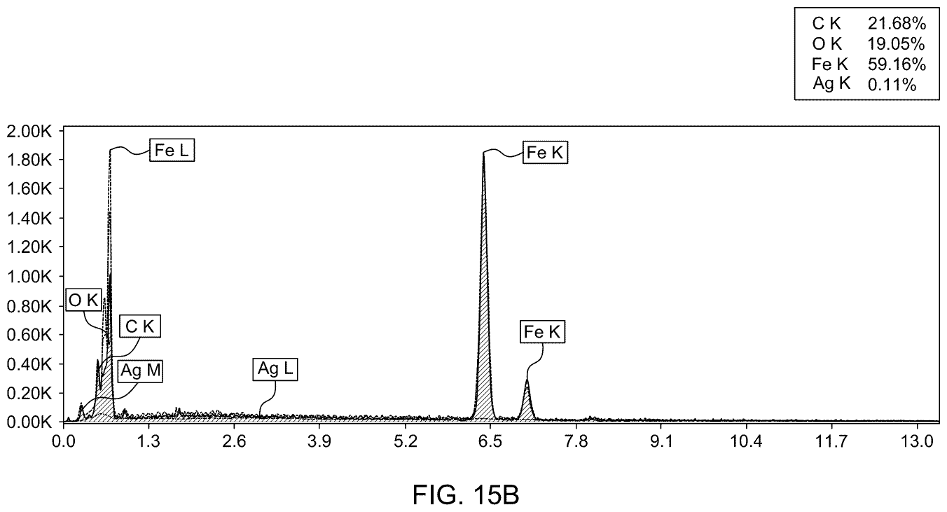

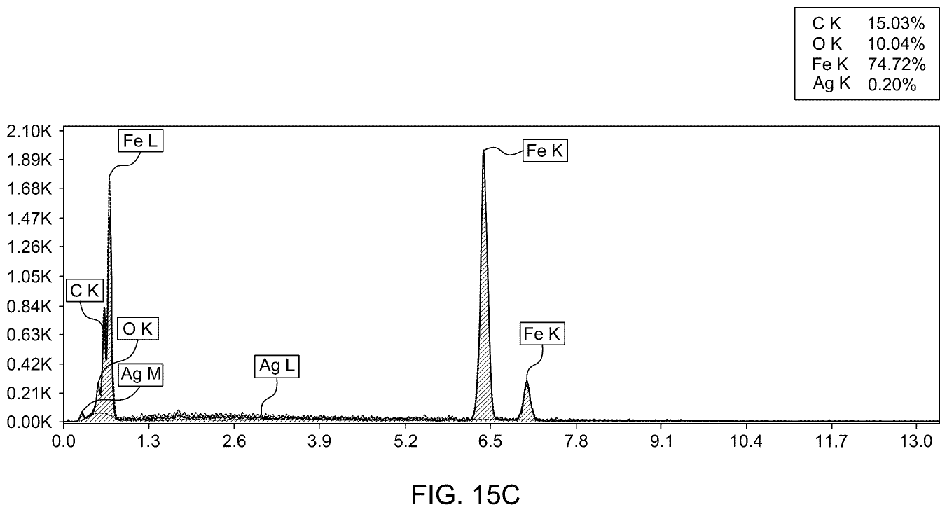

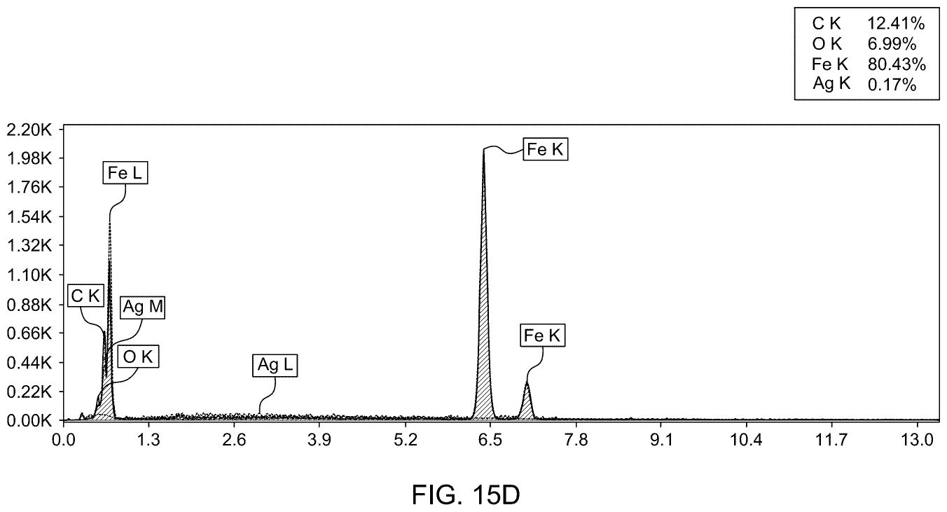

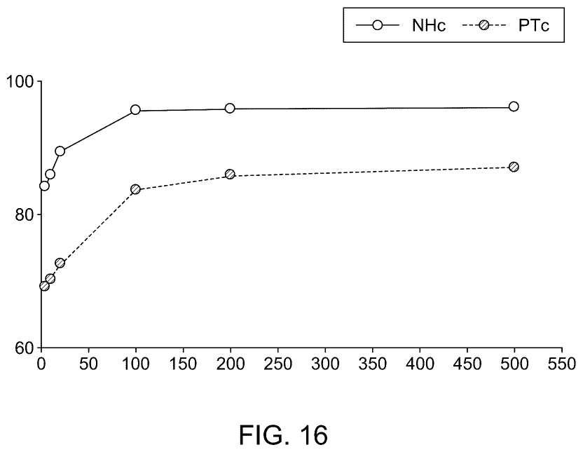

FIG. 8E depicts an SEM micrograph of the NHc composite at 500 μm magnification, according to certain embodiments;

FIG. 8F depicts an SEM micrograph of the NHc composite at 1 μm magnification, according to certain embodiments;

FIG. 8G depicts an SEM micrograph of the NHc composite at 2 μm magnification, according to certain embodiments;

FIG. 8H depicts an SEM micrograph of the NHc composite at 5 μm magnification, according to certain embodiments;

FIG. 9A depicts an SEM micrograph of a polished metal surface at 50 μm magnification, according to certain embodiments;

FIG. 9B depicts an SEM micrograph of a specimen in the absence of inhibitors (blank) a corrosive medium, at 50 μm magnification, according to certain embodiments;

FIG. 9C depicts an SEM micrograph of a specimen in presence of the inhibitor PTc, at 50 μm magnification, according to certain embodiments;

FIG. 9D depicts an SEM micrograph of a specimen in presence of the NHc composite in 1.0 molar (M) hydrochloric acid (HCl) at 500 parts per million (ppm), at 50 μm magnification, according to certain embodiments;

FIG. 10A depicts an SEM micrograph of the polished metal at 100 μm magnification, according to certain embodiments;

FIG. 10B depicts an SEM micrograph of the specimen in the absence of inhibitors (blank), at 100 μm magnification, according to certain embodiments;

FIG. 10C depicts an SEM micrograph of the specimen in presence of the inhibitor PTc, at 100 μm magnification, according to certain embodiments;

FIG. 10D depicts an SEM micrograph of the specimen in presence of the NHc composite in 1.0 M HCl at 500 ppm, at 100 μm magnification, according to certain embodiments;

FIG. 11 depicts an energy dispersive X-ray spectroscopy (EDX) spectrum of the AgNPs, according to certain embodiments;

FIG. 12 depicts an EDX spectrum of the NHc composite, according to certain embodiments;

FIG. 13 depicts a pore size distribution of the AgNPs, according to certain embodiments;

FIG. 14 depicts a pore size distribution of the NHc composite, according to certain embodiments;

FIG. 15A depicts an EDX spectrum of a freshly polished specimen, according to certain embodiments;

FIG. 15B depicts an EDX spectrum of the specimen in the absence of inhibitors (blank), according to certain embodiments;

FIG. 15C depicts an EDX spectrum of the specimen in presence of the inhibitor PTc, according to certain embodiments;

FIG. 15D depicts an EDX spectrum of the specimen in presence of the NHc composite, according to certain embodiments; and

FIG. 16 is a plot diagram depicting variation in corrosion inhibition efficiency with varying concentrations of PTc and the NHc composite, as obtained from weight loss technique at 25° C., according to certain embodiments.

### DETAILED DESCRIPTION

When describing the present disclosure, the terms used are to be construed in accordance with the following definitions, unless a context dictates otherwise.

Embodiments of the present invention will now be described more fully hereinafter with reference to the accompanying drawings wherever applicable, in that some, but not all embodiments of the disclosure are shown.

In the drawings, like reference numerals designate identical or corresponding parts throughout the several views. Further, as used herein, the words “a,” “an” and the like generally carry a meaning of “one or more,” unless stated otherwise.

As used herein, the words “about,” “approximately,” or “substantially similar” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, “nanoparticles” are particles having a particle size of, e.g., 1 nm to 1000 nm, or preferably 1 nm to 500 nm, within the scope of the present invention. The nanoparticles may exist in various morphological shapes, such as nanowires, nanocrystals, nanorectangles, nanosheets, nanotriangles, nanopentagons, nanohexagons, nanoprisms, nanodisks, nanocubes, nanoribbons, nanoblocks, nanobeads, nanotoroids, nanodiscs, nanobarrels, nanogranules, nanowhiskers, nanoflakes, nanofoils, nanopowders, nanoboxes, nanostars, tetrapods, nanobelts, nano-urchins, nanoflowers, etc. and mixtures thereof.

As used herein, the term “nanohybrid materials” generally refers to a physical composite containing two components normally inorganic nanoparticles and an organic matrix (preferably polymeric).

As used herein, the terms “particle size” and “pore size” may be thought of as the lengths or longest dimensions of a particle and a pore opening, respectively.

As used herein, the term “corrosion” generally refers to that material decomposes because chemical reaction occurs with its surrounding environment. There are two main types of corrosion: general or uniform attack corrosion and galvanic corrosion. Typical or uniform corrosion happens, for instance, when the iron is in a humid environment, creating iron oxide and corroding.

As used herein, a “corrosive medium” is a material that attacks and damages the surface it encounters.

As used herein, the term “corrosion inhibitor” generally refers to the chemical compound that, when added to a liquid or gas, decreases the corrosion rate of a material, typically a metal or an alloy, that meets the fluid. The effectiveness of a corrosion inhibitor may depend on fluid composition, quantity of water, and flow regime.

As used herein, the term “Schiff base” generally refers to a compound with the general structure R¹R²C═NR³ (R³=alkyl or aryl, but not hydrogen) and is considered as a subclass of imines, which are compounds consisting of carbon-nitrogen double bond.

As used herein, “compound” generally refers to a chemical entity, whether as a solid, liquid, or gas, and whether in a crude mixture or isolated and purified.

As used herein, the term “alkyl” unless otherwise specified refers to both branched and straight chain saturated aliphatic primary, secondary, and/or tertiary hydrocarbons of typically C₁ to C₂₀, preferably C₆-C₁₈, more preferably C₁₀-C₁₆, for example C₁, C₂, C₃, C₄, C₅, C₆, C₇, C₈, C₉, C₁₀, C₁₁, C₁₂, and specifically includes, but is not limited to, methyl, trifluoromethyl, ethyl, propyl, isopropyl, cyclopropyl, butyl, isobutyl, t-butyl, pentyl, cyclopentyl, isopentyl, neopentyl, hexyl, isohexyl, cyclohexyl, cyclohexylmethyl, 3-methylpentyl, 2,2-dimethylbutyl, 2,3-dimethylbutyl, 2-ethylhexyl, heptyl, octyl, nonyl, 3,7-dimethyloctyl, decyl, undecyl, dodecyl, tridecyl, 2-propylheptyl, tetradecyl, pentadecyl, hexadecyl, heptadecyl, octadecyl, nonadecyl, and eicosyl. As used herein, the term optionally includes substituted alkyl groups. Exemplary moieties with which the alkyl group can be substituted may be selected from the group including, but not limited to, hydroxyl, amino, alkylamino, arylamino, alkoxy, aryloxy, nitro, cyano, sulfonic acid, sulfate, phosphonic acid, phosphate, halo, or phosphonate or mixtures thereof. The substituted moiety may be either protected or unprotected as necessary, as known to those skilled in the art.

As used herein, the term “substituted” refers to at least one hydrogen atom that is replaced with a non-hydrogen group, provided that normal valences are maintained and that the substitution results in a stable compound. When a substituent is noted as “optionally substituted”, the substituents are selected from the exemplary group including, but not limited to, halo, hydroxyl, alkoxy, oxo, alkanoyl, aryloxy, alkanoyloxy, amino, alkylamino, arylamino, arylalkylamino, disubstituted amines (e.g. in which the two amino substituents are selected from the exemplary group including, but not limited to, alkyl, aryl or arylalkyl), alkanylamino, aroylamino, aralkanoylamino, substituted alkanoylamino, substituted arylamino, aubstituted aralkanoylamino, thiol, alkylthio, arylthio, arylalkylthio, alkylthiono, arylthiono, aryalkylthiono, alkylsulfonyl, arylsulfonyl, arylalkylsulfonyl, sulfonamide (e.g. —SO₂NH₂), substituted sulfonamide, nitro, cyano, carboxy, carbamyl (e.g. —CONH₂), substituted carbanyl (e.g. —CONHalkyl, —CONHaryl, —CONHarylalkyl or cases where there are two substituents on one nitrogen from alkyl, aryl, or alkylalkyl), alkoxycarbonyl, aryl, substituted aryl, guanidine, heterocyclyl (e.g. indolyl, imidazoyl, furyl, thienyl, thiazolyl, pyrrolidyl, pyridyl, pyrimidiyl, pyrrolidinyl, piperidinyl, morpholinyl, piperazinyl, homopiperazinyl and the like), substituted heterocyclyl and mixtures thereof and the like. The substituents may be optionally substituted and may be either unprotected or protected as necessary, as known to those skilled in the art, for example, as taught.

As used herein, the term “optionally” generally refers to includes substituted alkyl groups. The examples include, but are not limited to, hydroxy, amino, alkylamino, arylamino, alkoxy, aryloxy, nitro, cyano, sulfonic acid, sulfate, phosphonic acid, phosphate, halo, or phosphonate or mixtures thereof. The substituted moiety may be either protected or unprotected as necessary, as known to those skilled in the art.

As used herein, the term “cycloalkyl” generally refers to cyclized alkyl groups. Suitable examples of cycloalkyl groups include but are not limited to, cyclopropyl, cyclobutyl, cyclopentyl, cyclohexyl, norbornyl, and adamantly, 1-methylcyclopropyl and 2-methylcyclopropyl.

As used herein, the term “alkoxy” generally refers to a straight or branched chain alkoxy including, but not limited to, methoxy, ethoxy, propoxy, isopropoxy, butoxy, isobutoxy, secondary butoxy, tertiary butoxy, pentoxy, isopentoxy, hexyloxy, heptyloxy, octyloxy, nonyloxy, and decyloxy.

As used herein, the term “aryl” unless otherwise specified generally refers to functional groups or substituents derived from an aromatic ring including, but not limited to, phenyl, biphenyl, napthyl, thienyl, and indolyl.

As used herein, the term “halogen” generally refers to fluorine, chlorine, bromine and iodine.

As used herein, “inhibition efficiency” is a measure of effectiveness in inhibiting the corrosion of the metal article when in contact with the corrosive medium.

As used herein, the term “room temperature” generally refers to a temperature in a range of “25° C.±3° C. in the present disclosure.

A weight percent of a component, unless specifically stated to the contrary, is based on the total weight of the formulation or composition in which the component is included. For example, if a particular element or component in a composition or article is said to have 5 wt. %, it is understood that this percentage is in relation to a total compositional percentage of 100%.

Aspects of the present disclosure are directed to a nanohybrid chitosan (NHc) composite, and a method for inhibiting/reducing corrosion of any metal surface/metal article susceptible to corrosion in an acidic environment using the nanohybrid chitosan (NHc) composite. The NHc composite includes a matrix of a chitosan Schiff base having a Formula (I).

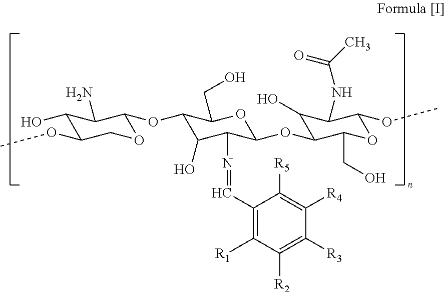

In some embodiments, R₁, R₂, R₃, R₄, and R₅ are each independently selected from the group consisting of a hydrogen atom, an optionally substituted alkyl, an optionally substituted cycloalkyl, an optionally substituted alkoxy, a hydroxyl group, a halogen group, an amine group, a nitro group, and a cyano group. In some embodiments, n is an integer from 2-500, preferably 10-490, preferably 20-480, preferably 30-470, preferably 40-460, preferably 50-450, preferably 60-440, preferably 70-430, preferably 80-420, preferably 90-410, preferably 100-400, preferably 110-390, preferably 120-380, preferably 130-370, preferably 140-360, preferably 150-350, preferably 160-340, preferably 170-330, preferably 180-320, preferably 190-310, preferably 200-300, preferably 210-290, preferably 220-280, preferably 230-270, and preferably 240-260. Other ranges are also possible.

In some embodiments, the chitosan Schiff base has a Formula (II)

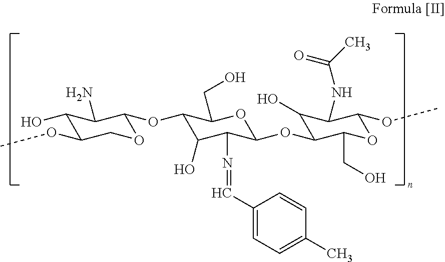

The NHc composite further includes one or more spherical silver nanoparticles (AgNPs) uniformly distributed throughout the matrix of the chitosan Schiff base. In some embodiments, the AgNPs have an average particle size of 5-50 nanometers (nm), preferably 10-45 nm, preferably 15-40 nm, preferably 20-35 nm, and preferably 25-30 nm. Other ranges are also possible.

¹H and ¹³C NMR spectra were recorded on a Bruker spectrometer (850 MHZ) using the deuterated DMSO and tetramethyl silane (TMS) as internal standards, respectively.

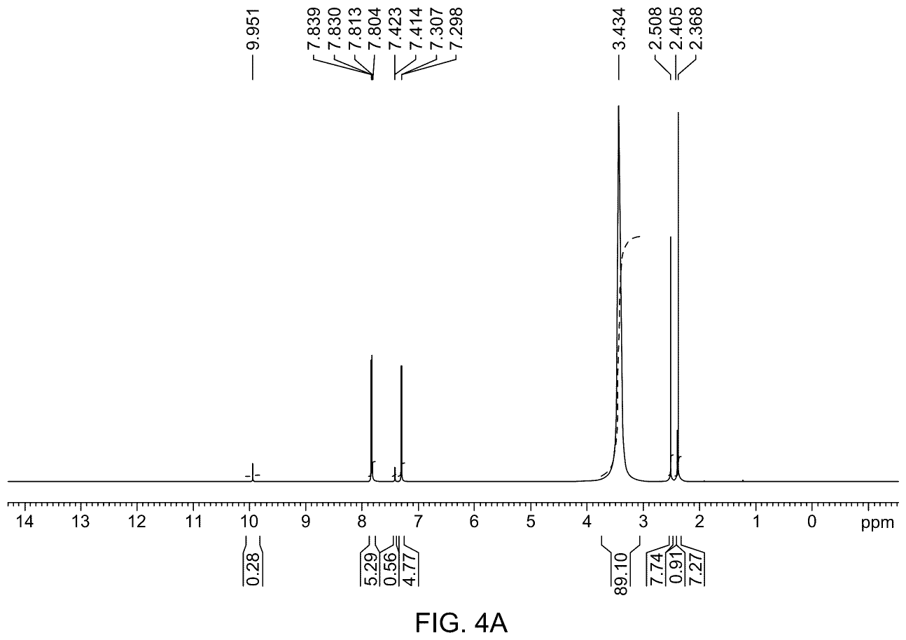

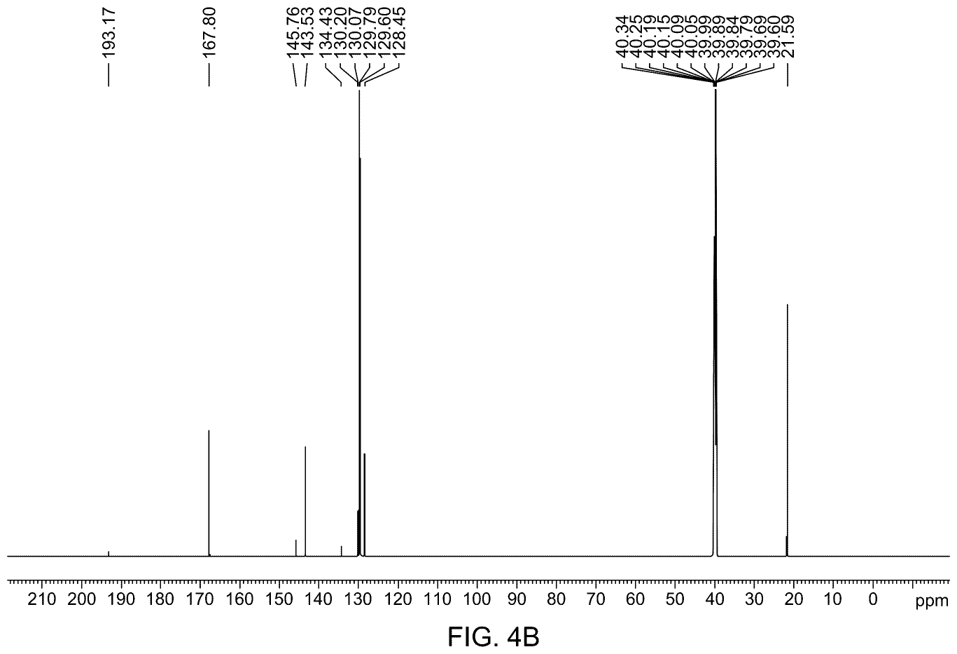

Referring to FIG. 4A, ¹H nuclear magnetic resonance (NMR) spectra of the chitosan Schiff base of formula (II) in DMSO. In some embodiments, the chitosan Schiff base has a first peak in a range of 2.1 to 2.7, or more preferably 2.3 to 2.51; a second peak in a range of 3.2 to 3.6, or more preferably about 3.43; a third peak in a range of 7.1 to 7.5, or more preferably 7.2 to 7.4; a fourth peak in a range of 7.5 to 7.9, or more preferably about 7.80 to 7.84; a fifth peak in a range of 9.8 to 10, or even more preferably about 9.9, as depicted in FIG. 4A. Other ranges are also possible.

Referring to FIG. 4B, ¹³C NMR spectra of the chitosan Schiff base of formula (II) in DMSO. In some embodiments, the chitosan Schiff base has a first peak in a range of 19 to 23, or more preferably about 21; a second peak in a range of 35 to 45, or more preferably 39 to 40; a third peak in a range of 126 to 136, or more preferably 128 to 134; a fourth peak in a range of 140 to 147, or more preferably 143 to 145; a fifth peak about 167; a sixth peak about 193, as depicted in FIG. 4B. Other ranges are also possible.

The crystalline structures of the NHc composite may be characterized by the Fourier transform infrared spectra (FTIR). FTIR spectra were studied by using Fourier transform infrared spectra (SHIMADZU). For the Fourier transform infrared spectra characterization, the KBr discs of the samples were prepared by mixing and grounding the samples with KBr powder in mortar with pestle. The mixture was then shaped into discs under mechanical pressure. The samples discs are put into Fourier transform infrared spectra and spectral measurements were recorded in the wavenumber range of 500-4000 cm⁻¹. Prior to the above measurement, the samples are vacuum-dried at 60° C. for a duration of 24 h.

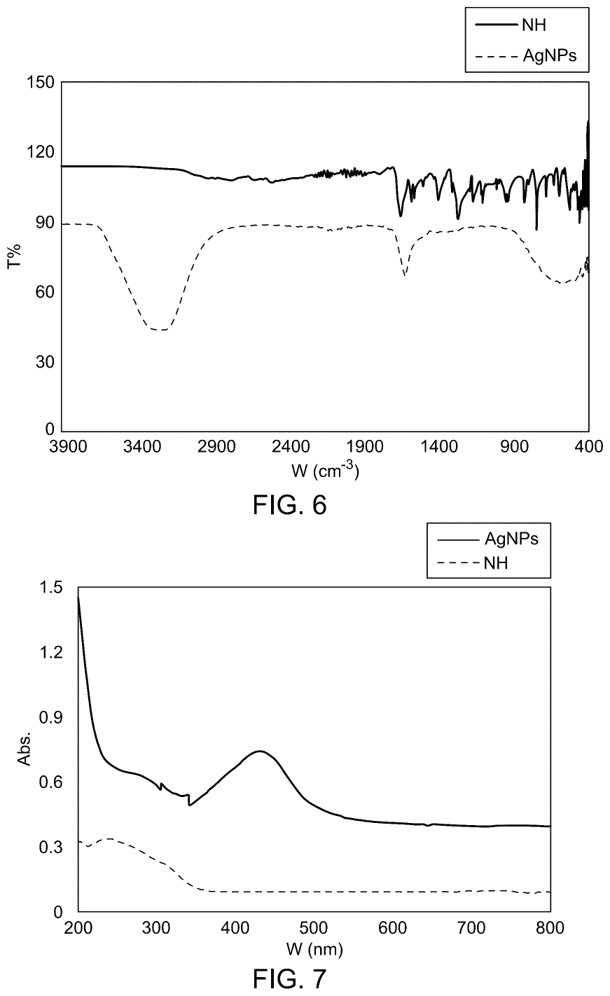

In some embodiments, the NHc composite has a first intense peak in a range of 400 to 900 cm⁻¹, a second intense peak in a range of 900 to 1400 cm⁻¹, a third intense peak in a range of 1400 to 1900 cm⁻¹, and a fourth intense peak in a range of 1900 to 2400 cm⁻¹ in an FTIR spectrum, as depicted in FIG. 6. Other ranges are also possible.

In some embodiments, the AgNPs interact with the matrix of the chitosan Schiff base derivative via an oxygen atom of a plurality of hydroxyl groups to form the NHc composite. In some embodiments, the AgNPs interact with the matrix of the chitosan Schiff base via a nitrogen atom of a plurality of amino groups to form the NHc composite, In some embodiments, the oxygen and nitrogen-rich structures in the hydroxyl and amino groups result in strong bonds with metal clusters and AgNPs through electrostatic interactions.

In some embodiments, the NHc composite has a porous structure including a plurality of interconnected pores, as depicted in FIGS. 8F to 8H. In some embodiments, the NHc composite has an average pore size of about 30-80 nm, preferably 31-79 nm, preferably 32-78 nm, preferably 33-77 nm, preferably 34-76 nm, preferably 35-75 nm, preferably 40-74 nm, preferably 41-73 nm, preferably 42-72 nm, preferably 43-71 nm, preferably 44-70 nm, preferably 45-69 nm, preferably 46-68 nm, preferably 47-67 nm, preferably 48-66 nm, preferably 49-65 nm, preferably 50-64 nm, preferably 51-63 nm, preferably 52-62 nm, preferably 53-61 nm, preferably 54-60 nm, preferably 55-59 nm, and or even more preferably 56-58 nm, as depicted in FIGS. 8F to 8H. Other ranges are also possible.

In some embodiments, the SEM-EDX analysis may be conducted to determine and analyze the surface morphology, as well as the elemental mapping of Ag, O, C, N, and Na elements present in AgNPs and the NHc composite with different AgNPs loadings. In some embodiments, the SEM analysis may be carried out on a JEOL-SEM analyzer (manufactured by JEOL, 11 Dearborn Road Peabody, MA, USA). In some further embodiments, the elemental mapping of Ag, O, C, N, and Na elements present in AgNPs and the NHc composite may be determined by EDX analysis. In this regard, a sample may be spread on a copper-covered stump. The sample was used to ensure proper analysis and high quality, and the image was magnified a million times. All the measurement may be conducted at ambient temperature.

In some embodiments, the NHc composite includes about 71-81 wt. % carbon, preferably 72-80 wt. %, preferably 73-79 wt. %, preferably 74-78 wt. %, or even more preferably 75-77 wt,% carbon; about 2-8 wt. % nitrogen, preferably 3-7 wt. %, or even more preferably 4-6 wt. % nitrogen; about 13-23 wt. % oxygen, preferably 14-22 wt. %, preferably 15-21 wt. %, preferably 16-20 wt. %, or even more preferably 17-19 wt. % oxygen; about 0.1-1 wt. % sodium, preferably 0.2-0.9 wt. %, preferably 0.3-0.8 wt. %, preferably 0.4-0.7 wt. %; or even more preferably 0.5-0.6 wt. % sodium and about 0.01-0.5 wt. % silver, preferably 0.05-0.45 wt. %, preferably 0.1-0.4 wt. %, preferably 0.15-0.35 wt. %, or even more preferably 0.2-0.3 wt. % silver, each wt. % based on total weight of the NHc composite, as determined by energy dispersive X-ray spectroscopy (EDX) and depicted in FIG. 12. In a preferred embodiment, the NHc composite includes about 76.08 wt. % carbon, about 4.75 wt. % nitrogen, about 18.68 wt. % oxygen, about 0.34 wt. % sodium, and about 0.15 wt. % silver, each wt. % based on the total weight of the NHc composite, as determined EDX. Other ranges are also possible.

In some embodiments, the AgNPs includes about 50-70 wt. % carbon, preferably 52-68 wt. %, preferably 54-66 wt. %, preferably 56-64 wt. %, or even more preferably 58-62 wt. % carbon; about 20-40 wt. % oxygen, preferably 22-38 wt. %, preferably 24-36 wt. %, preferably 26-34 wt. %, or even more preferably 28-32 wt. % oxygen; about 0.1-3 wt. % sodium, preferably 0.3-2.8 wt. %, preferably 0.5-2.6 wt. %, preferably 0.7-2.4 wt. %, or even more preferably 0.9-2.0 wt. % sodium; about 3-15 wt. % silver, preferably 4-13 wt. %, preferably 5-11 wt. %, preferably 6-9 wt. %, or even more preferably 7-8 wt. % silver; each wt. % based on total weight of the AgNPs, as determined by energy dispersive X-ray spectroscopy (EDX) and depicted in FIG. 11 (Cont'd). In a preferred embodiment, the AgNPs includes about 59.25 wt. % carbon, about 31.81 wt. % oxygen, about 1.38 wt. % sodium, about 7.56 wt. % silver, each wt. % based on the total weight of the AgNPs, as determined EDX and depicted in FIG. 11 (Cont'd). Other ranges are also possible.

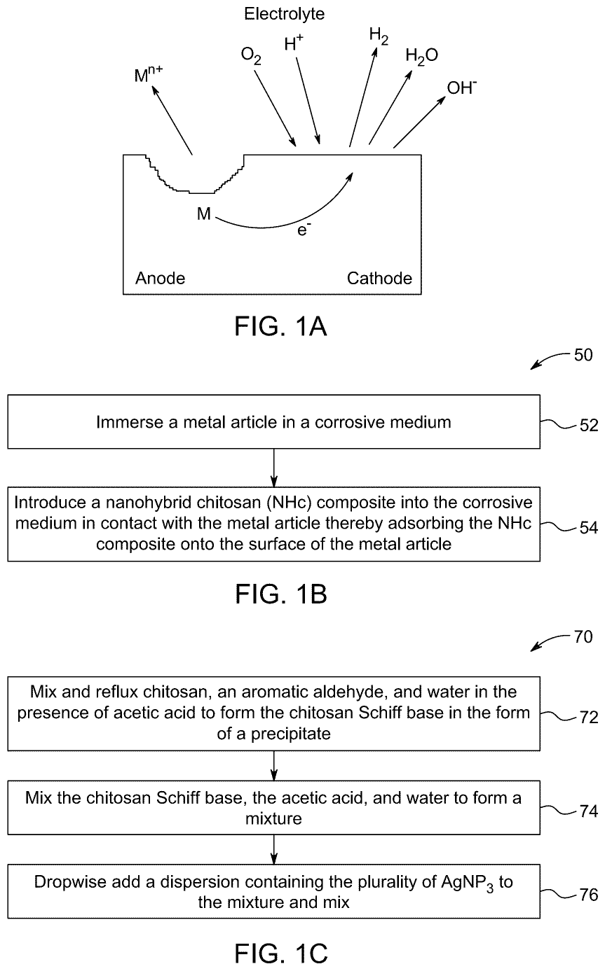

FIG. 1B illustrates a flow chart of a method 50 for inhibiting corrosion of a metal article in contact with a corrosive medium. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure.

At step 52, the method 50 includes immersing the metal article in a corrosive medium. The metal article to be protected may be any metal surface susceptible to corrosion in an acidic environment, including but not limited to, ferrous metals, low alloy metals (e.g., N-80 Grade), stainless steel, aluminum, copper alloys, brass, nickel alloys, and duplex stainless-steel alloys. In some embodiments, the metal article is made of at least one metal selected from the group consisting of carbon steel, carbon steel alloy, and mild steel. In a preferred embodiment, the metal article is a mild steel coupon. Such metal articles may be a part of a casing, a pipe, a pump, a screen, a valve, or a fitting of an oil or a gas well and the like. The metal article is at least partially immersed in the corrosive medium. The corrosive medium may be an acidic or alkaline liquid solution. In a preferred embodiment, the corrosive medium is an acidic liquid solution. In some embodiments, the corrosive medium includes one or more acids selected from hydrochloric acid (HCl), sulfuric acid (H₂SO₄), nitric acid (HNO₃), phosphoric acid (H₃PO₄), acetic acid, hydrofluoric acid (HF), and/or combinations of. In a preferred embodiment, the acid is HCl. Other acids are also possible. In some embodiments, the acid is present in the corrosive medium at a concentration of from 0.05 to 35 wt. %, preferably 5 to 25 wt. %, more preferably 12 to 18 wt. %, and yet more preferably 15 wt. % based on the total weight of the corrosive medium. Other ranges are also possible.

At step 54, the method 50 includes introducing the NHc composite into the corrosive medium in contact with the metal article thereby adsorbing the NHc composite onto the surface of the metal article. In some embodiments, the NHc composite is present in the corrosive medium in an amount of 1-1000 parts per million (ppm), preferably 50-950 ppm, preferably 100-900 ppm, preferably 150-850 ppm, preferably 200-800 ppm, preferably 250-750 ppm, preferably 300-700 ppm, preferably 350-650 ppm, preferably 400-600 ppm, or even more preferably 450-550 ppm, based on a total number of parts of the corrosive medium. In a preferred embodiment, the NHc composite is present in the corrosive medium in an amount of 100 ppm based on a total number of parts of the corrosive medium. Other ranges are also possible.

In some embodiments, the metal article is in contact with the corrosive medium containing the NHc composite for at least 12 hours, preferably at least 24 hours, preferably at least 12 days, preferably at least 24 days, preferably at least 36 days, or even more preferably at least 48 days. Other ranges are also possible.

In some embodiments, the metal article has a metal corrosion rate in a range of 3.153-0.802 millimeter penetration per year (mmpy), preferably 3-1.0 mmpy, preferably 2.8-1.2 mmpy, preferably 2.6-1.4 mmpy, preferably 2.4-1.6 mmpy, preferably 2.2-1.8 mmpy, or even more preferably about 2.0 mmpy when the NHc composite is present in the corrosive medium in a range of 5-500 ppm, preferably 100 to 400 ppm, or even more preferably 200 to 300 ppm, based on a total number of parts of the corrosive medium. Other ranges are also possible. In a preferred embodiment, the metal article has a metal corrosion rate of about 0.916 nmpy when the NHc composite is present in the corrosive medium in an amount of about 100 ppm based on a total number of parts of the corrosive medium. Other ranges are also possible.

The metal article adsorbs the NHc composite onto the surface of the metal article may form a barrier layer in the form of a composite. Referring to FIGS. 9A and 9D, the surface of the metal article containing the barrier layer has a smoother surface morphology compared to the surface of the metal article in contact with a corrosive medium without the presence of the NHc composite. In some embodiments, the barrier layer contains irregular shaped aggregates formed after contacting with the solution including the acid. In some embodiments, the aggregates have an average particle size in a range of 0.1 to 50 micrometers (m), preferably 0.5 to 20 m, preferably 1 to 10 m, or even more preferably 3 to 5 am. In some further embodiments, the barrier layer has an average thickness in a range of 10 to 1000 nanometers (nm), preferably 100 to 800 nm, preferably 200 to 700 nm, preferably 300 to 600 nm, or even more preferably 400 to 500 nm. Other ranges are also possible.

In some embodiments, the NHc composite is adsorbed onto the surface of the metal article via a chemical interaction, an electrochemical interaction, or a combination thereof. In some embodiments, the chemical interaction includes at least one of chemical reaction, chemical bonding, chemical dissolution, chemical precipitation, chemical adsorption, chemical desorption, and chemical complexation. In some further embodiments, the chemical interaction is chemical bonding which involves the formation of chemical bonds between atoms or molecules of the metal article and molecules of the NHc composite. In some preferred embodiments, the chemical bonding includes covalent bonding, ionic bonding, and metallic bonding, hydrogen bonding, van der Waals forces, and dipole-dipole interactions. In some most preferred embodiments, iron atoms of the metal article are covalently bonded to the NHc composite. In some embodiments, the electrochemical interaction includes at least one of oxidation, reduction, ionization, and dissolution of the NHc composite in the acid containing corrosive medium. In some further embodiments, the electrochemical interaction occurs between the metal article surface and the surrounding environment that led to the deterioration of the metal.

In some embodiments, the NHc composite is adsorbed onto the surface of the metal article at a temperature ranging from 303 to 333 kelvin (K), preferably 310 to 320 K, or even more preferably about 315 K. Other ranges are also possible.

In some embodiments, the metal article has a metal corrosion rate in a range of 6-3.15 mmpy, preferably 5.5-3.2 mmpy, preferably 5-3.25 mmpy, preferably 4.5-3.3 mmpy, preferably 4-3.35 mmpy, or even more preferably 3.5-3.4 mmpy when the chitosan schiff base of formula (I) is present in the corrosive medium in a range of 5-500 ppm, preferably 100 to 400 ppm, or even more preferably 200 to 300 ppm, based on the total number of parts of the corrosive medium. In a preferred embodiment, the metal article has a metal corrosion rate of about 3.307 mmpy when the chitosan schiff base of formula (I) is present in the corrosive medium in an amount of about 100 ppm based on a total number of parts of the corrosive medium. Other ranges are also possible.

In some embodiments, an inhibition efficiency in a range of, e.g., 84-99%, preferably 86 to 98%, preferably 88 to 97%, preferably 90 to 96%, or even more preferably 92 to 96% based on an initial weight of a metal article, is observed when the NHc composite is present in the corrosive medium in an amount in a range of 5-500 ppm, preferably 100 to 400 ppm, or even more preferably 200 to 300 ppm based on the total number of parts of the corrosive medium, as depicted in FIG. 16. Other ranges are also possible. In a preferred embodiment, an inhibition efficiency of about 95.44% based on an initial weight of the metal article, is observed when the NHc composite is present in the corrosive medium in an amount of about 100 ppm based on the total number of parts of the corrosive medium, as depicted in FIG. 16. Other ranges are also possible.

In some embodiments, an inhibition efficiency in a range of, e.g., 70-88%, preferably 72 to 86%, preferably 74 to 84%, preferably 76 to 82%, or even more preferably 78 to 80% based on an initial weight of a metal article, is observed when the chitosan schiff base of formula (I) is present in the corrosive medium in an amount in a range of 5-500 ppm, preferably 100 to 400 ppm, or even more preferably 200 to 300 ppm based on the total number of parts of the corrosive medium, as depicted in FIG. 16. Other ranges are also possible. In a preferred embodiment, an inhibition efficiency of about 83.52% based on an initial weight of the metal article, is observed when the chitosan schiff base of formula (I) is present in the corrosive medium in an amount of about 100 ppm based on the total number of parts of the corrosive medium, as depicted in FIG. 16. Other ranges are also possible.

In some embodiments, the corrosive medium may optionally include, but not limited to, surfactants, thickeners and/or viscosity modifiers, solubility modifiers, humectants, metal protecting agents, sequestrants and/or chelating agents, solidifying agent, sheeting agents, pH modifying components, including alkalinity and/or acidity sources, aesthetic enhancing agents (i.e., colorants, odorants, or perfumes), other cleaning agents, hydro tropes or couplers, and buffers.

The surfactant present in the corrosive medium may be non-ionic, anionic, cationic, or amphoteric. A non-ionic surfactant has no charged groups in its head. In some embodiments, the non-ionic surfactants may include alkanolamides of fatty acids, that is, amide reaction products between a fatty acid and an alkanolamine compound, such as coconut fatty acid monoethanolamide (e.g., N-methyl coco fatty ethanol amide), coconut fatty acid diethanolamide, oleic acid diethanolamide, and vegetable oil fatty acid diethanolamide. In some further embodiments, the non-ionic surfactants may include alkoxylated alkanolamides of fatty acids, preferably ethoxylated and/or propoxylated variants of the alkanolamides of fatty acids having anywhere from 2 to 30 EO and/or PO molar equivalents, preferably 3 to 15 EO and/or PO molar equivalents, preferably 4 to 10 EO and/or PO molar equivalents, preferably 5 to 8 EO and/or PO molar equivalents per moles of the alkanolamide of the fatty acid (e.g., coconut fatty acid monoethanolamide with 4 moles of ethylene oxide). In some preferred embodiments, the non-ionic surfactants may include amine oxides, such as N-cocoamidopropyl dimethyl amine oxide and dimethyl C6-C22 alkyl amine oxide (e.g., dimethyl coco amine oxide). In some further preferred embodiments, the non-ionic surfactants may include fatty esters, such as ethoxylated and/or propoxylated fatty acids (e.g., castor oil with 2 to 40 moles of ethylene oxide), alkoxylated glycerides (e.g., PEG-24 glyceryl monostearate), glycol esters and derivatives, monoglycerides, polyglyceryl esters, esters of polyalcohols, and sorbitan/sorbitol esters. In some even further preferred embodiments, the non-ionic surfactants may include ethers, such as (i) alkoxylated C1-C22 alkanols, which may include alkoxylated C1-C5 alkanols, preferably ethoxylated or propoxylated C1-C5 alkanols (e.g., dipropylene glycol n-butyl ether, tripropylene glycol n-butyl ether, dipropylene glycol methyl ether, tripropylene glycol methyl ether, diethylene glycol n-butyl ether, triethylene glycol n-butyl ether, diethylene glycol methyl ether, triethylene glycol methyl ether) and alkoxylated C6-C26 alkanols (including alkoxylated fatty alcohols), preferably alkoxylated C7-C22 alkanols, more preferably alkoxylated C8-C14 alkanols, preferably ethoxylated or propoxylated (e.g., cetyl stearyl alcohol with 2 to 40 moles of ethylene oxide, lauric alcohol with 2 to 40 moles of ethylene oxide, oleic alcohol with 2 to 40 moles of ethylene oxide, ethoxylated lanoline derivatives, laureth-3, ceteareth-6, ceteareth-11, ceteareth-15, ceteareth-16, ceteareth-17, ceteareth-18, ceteareth-20, ceteareth-23, ceteareth-25, ceteareth-27, ceteareth-28, ceteareth-30, isoceteth-20, laureth-9/myreth-9, and PPG-3 caprylyl ether), (ii) alkoxylated polysiloxanes, (iii) ethylene oxide/propylene oxide copolymers (e.g., PPG-1-PEG-9-lauryl glycol ether, PPG-12-buteth-16, PPG-3-buteth-5, PPG-5-buteth-7, PPG-7-buteth-10, PPG-9-buteth-12, PPG-12-buteth-16, PPG-15-buteth-20, PPG-20-buteth-30, PPG-28-buteth-35, and PPG-33-buteth-45), and (iv) alkoxylated alkylphenols.

Examples of surfactants include, but are not limited to, nonoxynol-9, poloxamers, tergitol, perfluorooctane sulfonate (PFOS), Pentax 99, benzalkonium chloride (BAC), cetylpyridinium chloride (CPC), and benzethonium chloride (BZT), betaines, and amino oxides.

In some embodiments, thickeners and/or viscosity modifiers include bauxite, bentonite, dolomite, limestone, calcite, vaterite, aragonite, magnesite, taconite, gypsum, quartz, marble, hematite, limonite, magnetite, andesite, garnet, basalt, dacite, nesosilicates or orthosilicates, sorosilicates, cyclosilicates, inosilicates, phyllosilicates, tectosilicates, kaolins, montmorillonite, fullers earth, halloysite, polysaccharide gelling agents (e.g., xanthan gum, scleroglucan, and diutan) as well as synthetic polymer gelling agents (e.g., polyacrylamides and co-polymers thereof), psyllium husk powder, hydroxyethyl cellulose, carboxymethylcellulose, and polyanionic cellulose, poly(diallyl amine), diallyl ketone, diallyl amine, styryl sulfonate, vinyl lactam, laponite. In some embodiments, the chelating agents as sequesteration agents of metal ions, include ethylene diamine tetraacetic acid (EDTA), diethylene triamine pentaacetic acid (DPTA), hydroxyethylene diamine triacetic acid (HEDTA), ethylene diamine di-ortho-hydroxy-phenyl acetic acid (EDDHA), ethylene diamine di-ortho-hydroxy-para-methyl phenyl acetic acid (EDDHMA), ethylene diamine di-ortho-hydroxy-para-carboxy-phenyl acetic acid (EDDCHA). In some embodiments, the stabilizing agents include polypropylene glycol, polyethylene glycol, carboxymethyl cellulose, hydroxyethyl cellulose, polysiloxane polyalkyl polyether copolymers, acrylic copolymers, alkali metal alginates and other water-soluble alginates, carboxyvinyl polymers, polyvinylpyrollidones, polyacrylates. In some embodiments, the dispersing agents include polymeric or co-polymeric compounds of polyacrylic acid, polyacrylic acid/maleic acid copolymers, styrene/maleic anhydride copolymers, polymethacrylic acid and polyaspartic acid. In some embodiments, the scale inhibitors include sodium hexametaphosphate, sodium tripolyphosphate, hydroxyethylidene diphosphonic acid, aminotris(methylenephosphonic acid (ATMP), vinyl sulfonic acid, allyl sulfonic acid, polycarboxylic acid polymers such as polymers containing 3-allyloxy-2-hydroxy-propionic acid monomers, sulfonated polymers such as vinyl monomers having a sulfonic acid group, polyacrylates and copolymers thereof. In some embodiments, the defoaming agents include silicone oils, silicone oil emulsions, organic defoamers, emulsions of organic defoamers, silicone-organic emulsions, silicone-glycol compounds, silicone/silica adducts, emulsions of silicone/silica adducts.

FIG. 1C illustrates a flow chart of a method 70 for preparing the NHc composite. The order in which the method 70 is described is not intended to be construed as a limitation, and any number of the described method steps can be combined in any order to implement the method 70. Additionally, individual steps may be removed or skipped from the method 70 without departing from the spirit and scope of the present disclosure.

At step 72, the method 70 include mixing and refluxing chitosan, an aromatic aldehyde, and water in the presence of acetic acid to form the chitosan Schiff base in the form of a precipitate. Chitosan has a mild organic base structure that can produce salts when it comes into contact with weak acids. Suitable examples of weak acids include formic acid, acetic acid, benzoic acid, and oxalic acid. In a preferred embodiment, the weak acid is acetic acid. Suitable examples of aromatic aldehydes include bezaldehyde, napthaldehyde, vanillin, ethyl-vanillin, o-tolualdehyde, m-tolualdehyde and p-tolualdehyde. In a preferred embodiment, the aromatic aldehyde is p-tolualdehyde. In some embodiments, a molar ratio of the chitosan to the aromatic aldehyde present in the mixture is about 1:1-1:20, preferably 1:2-1:19, preferably 1:3-1:18, preferably 1:4-1:17, preferably 1:5-1:16, preferably 1:6-1:15, preferably 1:7-1:14, preferably 1:8-1:13, preferably 1:9-1:12, or even more preferably 1:10-1:11. Other ranges are also possible.

At step 74, the method 70 includes mixing the chitosan Schiff base, acetic acid, and water to form a mixture. The mixing may be carried out manually or with the help of a magnetic stirrer. In some embodiments, the chitosan Schiff base is present in the mixture at a concentration of 0.002-0.02 grams per milliliter (g/ml), preferably 0.003-0.019 g/ml, preferably 0.004-0.018 g/ml, preferably 0.005-0.017 g/ml, preferably 0.006-0.016 g/ml, preferably 0.007-0.015 g/ml, preferably 0.008-0.014 g/ml, preferably 0.009-0.013 g/ml, or even more preferably 0.010-0.012 g/ml based the total volume of the mixture. Other ranges are also possible.

At step 76, the method 70 includes dropwise adding a dispersion containing the plurality of AgNP₃ to the mixture and mixing. In some embodiments, the AgNP₃ are present in the dispersion at a concentration of 0.005-0.05 milligrams per milliliter (mg/ml), preferably 0.006-0.045 mg/ml, preferably 0.007-0.04 mg/ml, preferably 0.008-0.035 mg/ml, preferably 0.009-0.03 mg/ml, preferably 0.01-0.025 mg/ml, or even more preferably 0.015-0.02 mg/ml based the total volume of the dispersion. Other ranges are also possible.

### EXAMPLES

The following examples demonstrate methods of preventing/reducing/inhibiting corrosion of a metal surface from a corrosive medium using a nanohybrid chitosan composite (NHc), as described herein. The examples are provided solely for illustration and are not to be construed as limitations of the present disclosure, as many variations thereof are possible without departing from the spirit and scope of the present disclosure.

### Example 1: Materials and Methods

All glassware used to prepare the samples was rinsed with soap, tap water, acetone, and distilled water, then dried in an oven at 80° C. The experiment was installed using a facile one-pot protocol under the fume hood. All samples were prepared in a clean atmosphere and under an oil bath at 100° C. The equipment includes the facile one-pot protocol (reflux system), oil bath, sensitive balance, hose water, heating magnetic stirrer, and Büchner funnel. All chemicals were obtained from Sigma-Aldrich (St Louis Mo, USA): chitosan (low Mw), p-tolualdehyde, acetic acid (99%), silver nanospheres (AgNPs), and acetone.

### Example 2: Apparatus

Spectro photometer (8UVD11064, Somatko, 2013) was used for ground-state electronic absorption spectra. Fourier transform infrared-spectroscopy (FTIR) spectra were obtained on SHIMADZU with a universal attenuated total reflectance (ATR) sampling accessory. Scanning electron microscopy (SEM) images were obtained using a scanning electron microscope (SEM) (FEI, Inspect S50). ¹H nuclear magnetic resonance (NMR) and ¹³C NMR measurements in deuterated dimethyl sulfoxide (DMSO) were performed using a Bruker spectrometer, 850 MHz. DMSO and tetramethyl silane (TMS) were used to prepare the samples and as internal standard respectively with chemical shifts (6) in part per million (ppm).

### Example 3: Preparation of p-Tolualdehyde-Chitosan Schiff Base Derivative

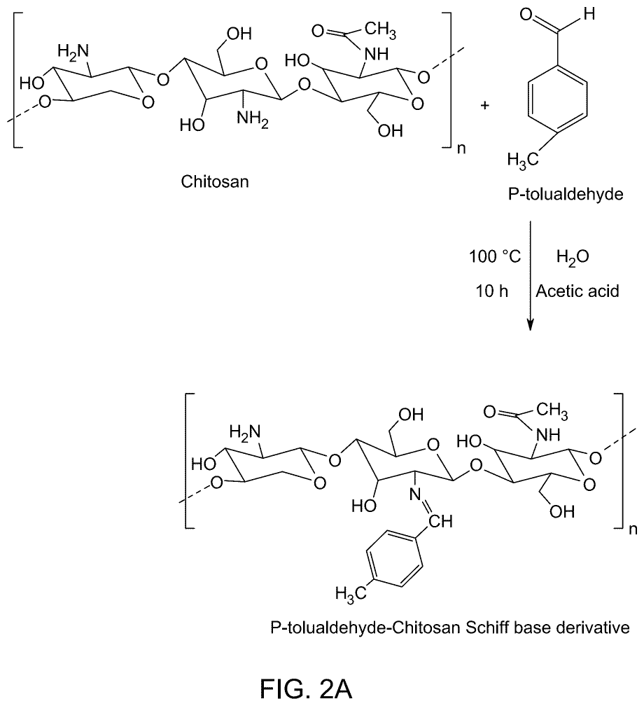

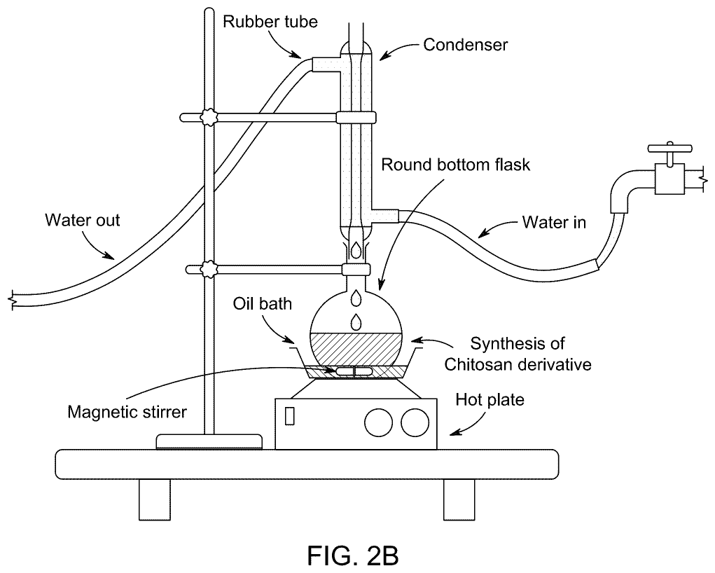

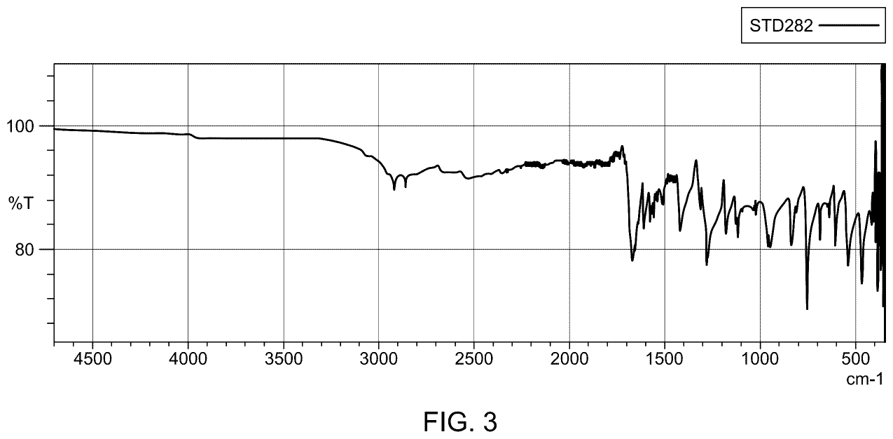

The reaction scheme depicting the preparation of the p-tolualdehyde-chitosan Schiff base derivative (chitosan derivative) is shown in FIG. 2A. In a round-bottom flask, 1.612 grams (g) of chitosan, 1.2 ml of p-tolualdehyde, 80 ml of de-ionized (DI) water, and 5 ml of 99% acetic acid was added. Further, the mixture was refluxed and stirred for 10 hours (h) at 100° C. The chitosan derivative was obtained by filtering with a Büchner funnel after precipitation, drying for 42 h, and washing with acetone. The designed assembly for this experiment is shown in FIG. 2B. The synthesized chitosan derivative was further characterized by FTIR; as depicted in FIG. 3. The FTIR spectra provides information about the functional groups of the p-tolualdehyde-chitosan Schiff base derivative. The prepared compound showed absorption at 2918.62 cm⁻¹ and 2848.79 cm⁻¹ that is assigned to C—H stretching (See: Biao, L., Tan, S., Wang, Y., Guo, X., Fu, Y., Xu, F., . . . & Liu, Z. 2017. Synthesis, characterization and antibacterial study on the chitosan-functionalized Ag nanoparticles, which is incorporated herein by reference in its entirety). Additionally, the band at 1668.80 cm⁻¹ attributed to (C═N) vibrations characteristic of imines (See: Smith, P. A. S. (1965). The chemistry of open-chain organic nitrogen compounds and Subasi, N. T. (2022). Overview of Schiff Bases. In Schiff Base in Organic, Inorganic and Physical Chemistry, which is incorporated herein by reference in its entirety). The peak at 1576.17 cm⁻¹ is attributed to (C═C) stretching in the aromatic ring of aldehyde and to the N—H bending (See: Guinesi, L. S., & Cavalheiro, É. T. G. (2006). Influence of some reactional parameters on the substitution degree of biopolymeric Schiff bases prepared from chitosan and salicylaldehyde, which is incorporated herein by reference in its entirety). The absorption at 1281.17 cm⁻¹ attributed to (C—N) stretching (See: Kong, P., Feng, H., Chen, N., Lu, Y., Li, S., & Wang, P. (2019). Polyaniline/chitosan as a corrosion inhibitor for mild steel in acidic medium, which is incorporated herein by reference in its entirety). In addition to the appearance of band at 1117.28 cm⁻¹ for the polysaccharide moiety and band at 1021.80 cm⁻¹ correspond to (C—O—C) stretching. The band at 835.11 cm⁻¹ is attributed to para substitution in the aromatic ring of aldehyde. Moreover, the peak at 751.03 cm⁻¹ was assigned to the pyridine ring. The ¹H NMR and the ¹³C NMR provided information about the molecular environment of the carbon (C) and hydrogen (H) of p-tolualdehyde-chitosan Schiff base derivative as shown in FIG. 4A and FIG. 4B, respectively.

FIG. 4A depicts the ¹H NMR values of the chitosan derivative δ: 2.36 (s, 3H, —Ar—CH₃), 2.40-2.50 (s, 4H, —CH— corresponds to the deacetylated monomer of D-glucosamine), 7.29-7.83 (m, 4H, Aromatic ring), 9.95 (s, 1H, —C—CH═N—)—) (See: Lai, X., Hu, J., Ruan, T., Zhou, J., & Qu, J. (2021). Chitosan derivative corrosion inhibitor for aluminum alloy in sodium chloride solution: A green organic/inorganic hybrid, which is incorporated herein by reference in its entirety). Further, FIG. 4B depicts the ¹³C NMR values of the chitosan derivative δ: 21.59 (IC, —CH—Ar—C-3), 128.45-145.76 (6C, Aromatic ring), 167.80 (1C, Ar—CH═N).

### Example 4: Preparation of p-Tolualdehyde-Chitosan AgNPs (NHc Nanocomposite)

About 0.03 g of the chitosan derivative previously prepared was dissolved in 5 ml of DI water. To this was added 5 drops of 99% acetic acid. Then, 5 ml of AgNPs were added dropwise for 15 minutes. The combination was continuously stirred at room temperature for 24 h to obtain p-tolualdehyde-chitosan AgNPs, as shown in FIG. 5A. The designed assembly for this experiment is shown in FIG. 5B.

FIG. 6 depicts the FTIR spectra (KBr, cm⁻¹) for the functional groups of the AgNPs and the NHc composite. The results of the infrared spectroscopy (IR) show the presence of a stretching band of (O—H) at 3285.29 cm⁻¹ in the AgNPs and a bending bond of (C═O) at 1638.37 cm⁻¹ while the peak of hydroxyl in the NHc composite disappeared. Furthermore, the NHc composite showed absorption at 1671.18 cm⁻¹ attributed to (C═N) vibrations characteristic of imines. The peak at 1575.60 cm⁻¹ is attributed to (C═C) stretching in the aromatic ring of aldehyde and to the N—H bending. The absorption at 1281.02 cm⁻¹ attributed to (C—N) stretching (See: Kong, P., Feng, H., Chen, N., Lu, Y., Li, S., & Wang, P. (2019). Polyaniline/chitosan as a corrosion inhibitor for mild steel in acidic medium, which is incorporated herein by reference in its entirety). In addition, the 20 appearance of the band at 1116.97 cm⁻¹ for the polysaccharide moiety and the band at 1022.11 cm⁻¹ correspond to (C—O—C) stretching. The bands at 810 cm⁻¹, and 829.52 cm⁻¹ are attributed to para substitution in the aromatic ring of aldehyde. Moreover, the peak at 751.03 cm⁻¹ was assigned to the pyridine ring.

### Example 5: Characterization by Ultraviolet-Visible (UV-Visible) Spectra

AgNPs react with the prepared chitosan derivative to form the NHc composite. The presence of nanosized inter- and intramolecular pools in polysaccharides, which may be used as templates in the creation of nanoparticles, is therefore well recognized (See: Raveendran, P., Fu, J., & Wallen, S. L. (2003). Completely “green” synthesis and stabilization of metal nanoparticles. Journal of the American Chemical Society, which is incorporated herein by reference in its entirety). Additionally, as illustrated in FIG. 5A, their oxygen and nitrogen-rich structures in the hydroxyl and amino groups result in strong bonds with metal clusters and nanoparticles through electrostatic interactions. (See: Huang, L., Zhai, M. L., Long, D. W., Pieng, J., Xu, L., Wu, G. Z, . . . & Wei, G. S. (2008). UV-induced synthesis, characterization and formation mechanism of silver nanoparticles in alkalic carboxymethylated chitosan solution, which is incorporated herein by reference in its entirety). The UV data shown in FIG. 7 confirmed the formation of silver nanoparticles and the NHc composite. The characteristic of the absorption peak in AgNPs appeared at 432 nanometers (nm) (See: Elsharif, A. M, Abdulazeez, L, Almarzooq, M. A., & Haladu, S. A. (2022). Synthesis, and experimental evaluation of novel 4-(-3-(2-hydroxyethoxy)-3-oxopropenyl)-1, 2-phenylene nanohybrid derivatives as potential corrosion inhibitors for mild steel in 1 M HCl, which is incorporated herein by reference in its entirety). It is a characteristic peak of silver nanoparticles, while in the NHc composite, the absorption peak disappeared, and this is due to the low percentage of silver in the NHc composite.

### Example 6: Surface Characterization by SEM

The morphological analysis of the AgNPs and the NHc composite was performed using SEM with different magnifications. SEM images reveal that different morphologies were observed for AgNPs and the NHc composite, as shown in FIG. 8. FIG. 8A, FIG. 8B, FIG. 8C, and FIG. 8D depicts the appearance of the particles. As per the analysis, the particles appeared crystalline and spherical. FIGS. 8A-8D symbolized the size of polycrystalline particles of AgNPs and showed a range of sizes of approximately 5 nm to 50 nm. Some larger nanoparticles attributed to the fact that silver nanoparticles could agglomerate due to their high surface energy. On the nanometer scale, some of the silver nanoparticles contributed to growing into twinned particles. On the other hand, FIG. 8E, FIG. 8F, FIG. 8G, and FIG. 8H illustrates the SEM micrographs depicting a sponge sponge-like morphology with a porous structure with a network of interconnected pores of different micrometric sizes.

Surface morphology and characteristics of mild steel samples were examined utilizing SEM. This scrutiny was carried out under two distinct conditions: one set of samples immersed in a one molar hydrochloric acid (HCl) solution for a duration of 1 day (equivalent to 24 hours), and another set immersed in the same HCl solution containing the newly synthesized derivatives PTc and NHc. The outcome of the study is depicted in FIG. 9 and FIG. 10, respectively. The SEM analysis shows the alterations and corrosion behaviors of the mild steel samples under the influence of these different environments, and unveiling the impact of the newly synthesized derivatives on the surface properties of the material, FIG. 9A and FIG. 10A depicts freshly polished mild steel samples, showcasing a clean and smooth surface at varying magnifications of 50 micrometers (μm) and 100 μm, respectively. The inhibitors, PTc and the NHc composite, exhibited an effect on the surface of mild steel samples, forming a protective film and a smoother surface, as evidenced in FIG. 9C & FIG. 9D (with the PTc) and FIG. 10C, and FIG. 10D (with the NHc composite) at 50 μm and 100 μm, respectively. These micrographs displayed a contrast between the samples treated with and without the inhibitors. In the presence of these inhibitors, the corrosive action of the one molar HCl solution was mitigated, leading to reduced damage, pitting, and corrosion. The protective film formed by the inhibitors acted as a barrier, preventing the aggressive attack of acid on the metal surface. The samples exposed to the one molar HCl solution without the inhibitors showed cracking, pitting, and extensive corrosion, as depicted in FIG. 9B and FIG. 10B at 50 μm and 100 μm, respectively. This stark difference underscores the role that PTc and NHc play in safeguarding the integrity and surface quality of mild steel when exposed to harsh, acidic environments.

### Example 7: Energy-Dispersive X-Ray Spectroscopy (EDX)

Silver (Ag), oxygen (O), carbon (C), nitrogen (N), and sodium (Na) elements were detected by EDX analysis onto AgNPs and the NHc composite. The strongest signal from silver in AgNPs was observed, while in the NHc composite the percentage decreased. The elemental mapping images of these elements in different areas of AgNPs are depicted in FIG. 11 and the elemental mapping images of the NHc composite are depicted in FIG. 12. The elemental mapping shows a heterogeneous distribution with quite different percentages of the elements such as Ag and Na. Further, it can be observed that the pores in the NHc composite (FIG. 14) present an increase in average size when compared to the AgNPs (FIG. 13). Additionally, the size distribution of pores in the NHc composite (45 nm) shows better dispersity than that of the AgNPs (39 nm), which can be attributed to a diffusion effect within the nanopores in the NHc composite.

FIG. 15 depicts the elemental composition of the four examined samples including, the freshly polished, blank, PTc-treated, and NHc-treated samples, as revealed through EDX analysis. This analysis unveiled variations in the percentages of key elements, particularly iron (Fe), across the samples. The freshly polished sample exhibited the highest Fe percentage at 85.84%, followed by 80.43% in the NHc-treated sample and 74.72% in the PTc-treated sample. The blank sample displayed the lowest Fe percentage at 59.16% while simultaneously registering the highest oxygen percentage at 19.05%. Further, the EDX results also highlighted the presence of other elements, such as silver (Ag) at varying levels, with values of 0.23%, 0.11%, 0.20%, and 0.17% for the freshly polished, blank, PTc-treated, and NHc-treated samples, respectively. Carbon content was also observed in the samples, with percentages of 8.77%, 21.68%, 15.03%, and 12.41%, respectively, for the same set of samples. These findings in elemental compositions and variations among the different samples show characteristic properties of the material.

### Example 8: Weight Loss Measurements for PTc and the NHc Composite

The weight loss technique utilizes the loss in mass of the metal exposed to a corrosive solution during a pre-determined time as a direct measure for the quantitative evaluation of corrosion. The results of weight loss corrosion tests on mild-steel coupons submerged in 1.0 molar (M) HCl at 298 K for 24 hours, both in the absence and presence of the inhibitor molecules are shown in Table 1. In the absence of the inhibitor molecules, the mild-steel coupon experienced rapid dissolution at a rate of 20.073-millimetre penetration per year (mmpy). However, the rate of dissolution was reduced in the presence of the inhibitor molecules, with PTc having a corrosion rate of 3.307 mmpy, and the NHc nanocomposite showed the lowest corrosion rates of 0.916 mmpy and the highest inhibition efficiencies, 95.44% at 100 ppm.

TABLE 1
Mild steel corrosion and inhibition efficiency data in 1.0M
HCl in the presence and absence of the PTc and NHc at 100 ppm.

| Medium | Corrosion rate (mmpy) | Inhibition efficiency (%) |
|---|---|---|
| Blank | 20.073 | Nil |
| PTc | 3.307 | 83.52 |
| NHc nanocomposite | 0.916 | 95.44 |

Additionally, the variation of the corrosion inhibition efficiency upon adding the different strengths of PTc and the NHc composite as depicted in FIG. 16. It can be seen from FIG. 16, that the inhibition efficiency increases with an increase in concentration; and reaches up to 86.99% at a concentration of 500 ppm of PTc and exhibited the highest inhibition efficiency of 96 at 500 ppm, in presence of the NHc composite. The inhibitory efficiency observed by the NHc composite was partially a result of their improved electrical properties and because of the presence of AgNPs, which makes it easier for molecules to bind to the surface of mild-steel while blocking the anodic and cathodic processes. The overall corrosion data are summarized in Table 2.

TABLE 2
Mild-steel corrosion data in 1.0M HCl in the presence
and absence of PTc and the NHc composite.

| | 298 K | | | 313 K | | | 333 K | | |
|---|---|---|---|---|---|---|---|---|---|
| Medium/Inhibitor | CR | | | CR | | | CR | | |
| concentration (ppm) | (mmpy) | θ | η (%) | (mmpy) | θ | η (%) | (mmpy) | θ | η (%) |
| Blank | 20.073 | — | — | 21.733 | — | — | 26.808 | — | — |
| PTc | | | | | | | | | |
| 5 | 6.178 | 0.692 | 69.22 | 19.376 | 0.108 | 10.85 | 24.827 | 0.074 | 7.39 |
| 10 | 5.944 | 0.704 | 70.39 | 18.067 | 0.169 | 16.87 | 23.400 | 0.127 | 12.71 |
| 20 | 5.534 | 0.724 | 72.43 | 14.914 | 0.314 | 31.38 | 22.206 | 0.172 | 17.17 |
| 100 | 3.307 | 0.835 | 83.52 | 11.141 | 0.487 | 48.74 | 21.655 | 0.192 | 19.22 |
| 200 | 2.864 | 0.857 | 85.73 | 9.139 | 0.579 | 57.95 | 20.381 | 0.240 | 23.98 |
| 500 | 2.612 | 0.870 | 86.99 | 7.816 | 0.640 | 64.04 | 19.344 | 0.278 | 27.84 |
| NHc | | | | | | | | | |
| 5 | 3.153 | 0.843 | 84.29 | 18.515 | 0.148 | 14.81 | 22.939 | 0.144 | 14.43 |
| 10 | 2.819 | 0.860 | 85.96 | 14.216 | 0.346 | 34.59 | 21.655 | 0.192 | 19.23 |
| 20 | 2.139 | 0.893 | 89.34 | 10.035 | 0.538 | 53.82 | 21.069 | 0.214 | 21.41 |
| 100 | 0.916 | 0.954 | 95.44 | 7.127 | 0.672 | 67.21 | 20.586 | 0.232 | 23.21 |
| 200 | 0.847 | 0.958 | 95.78 | 6.980 | 0.679 | 67.88 | 20.271 | 0.244 | 24.38 |
| 500 | 0.802 | 0.960 | 96.00 | 6.485 | 0.702 | 70.16 | 20.240 | 0.245 | 24.50 |

Numerous modifications and variations of the present disclosure are possible in light of the above teachings. It is therefore to be understood that within the scope of the appended claims, the invention may be practiced otherwise than as specifically described herein.

1. A nanohybrid chitosan (NHc) composite, comprising:
a matrix of a chitosan Schiff base having a formula (I) 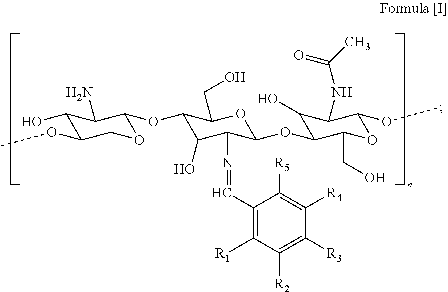
wherein R₁, R₂, R₃, R₄, and R₅ are each independently selected from the group consisting of a hydrogen atom, an optionally substituted alkyl, an optionally substituted cycloalkyl, an optionally substituted alkoxy, a hydroxyl group, a halogen group, an amine group, a nitro group, and a cyano group; and
wherein “n” is an integer from 2 to 500;
a plurality of spherical silver nanoparticles (AgNPs) uniformly distributed throughout the matrix of the chitosan Schiff base;
wherein the NHc composite has a porous structure comprising a plurality of interconnected pores.

2. The NHc composite of claim 1, wherein the AgNPs have an average particle size of 5 nanometers (nm) to 50 nm.

3. The NHc composite of claim 1, wherein the chitosan Schiff base has a formula (II)

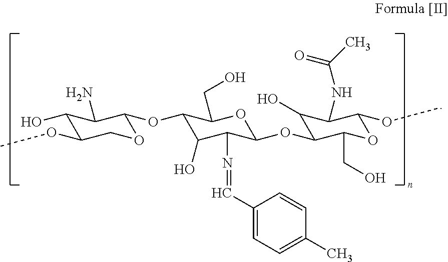

4. The NHc composite of claim 1, and wherein the AgNPs are interacting with the matrix of the chitosan Schiff base derivative via an oxygen atom of a plurality of hydroxyl groups to form the NHc composite.

5. The NHc composite of claim 1, wherein the AgNPs are interacting with the matrix of the chitosan Schiff base via a nitrogen atom of a plurality of amino groups to form the NHc composite.

6. The NHc composite of claim 1, having an average pore size of about 30 nm to 80 nm.

7. The NHc composite of claim 1, comprising about 71 weight percentage (wt. %) to 81 wt. % carbon, about 2 wt. % to 8 wt. % nitrogen, about 13 wt. % to 23 wt. % oxygen, about 0.1 wt. % to 1 wt. % sodium, and about 0.01 wt. % to 0.5 wt. % silver, each wt. % based on a total weight of the NHc composite, as determined by energy dispersive X-ray spectroscopy (EDX).

8. The NHc composite of claim 7, comprising about 76.08 wt. % carbon, about 4.75 wt. % nitrogen, about 18.68 wt. % oxygen, about 0.34 wt. % sodium, and about 0.15 wt. % silver, each wt. % based on a total weight of the NHc composite, as determined EDX.

9. A method for inhibiting corrosion of a metal article in contact with a corrosive medium comprising an acid, the method comprising:
immersing the metal article in the corrosive medium; and
introducing the NHc composite of claim 1 into the corrosive medium in contact with the metal article thereby adsorbing the NHc composite onto a surface of the metal article;
wherein the NHc composite is present in the corrosive medium in an amount of 1 parts per million (ppm) to 1000 ppm based on a total number of parts of the corrosive medium.

10. The method of claim 9, wherein the metal article is made of at least one metal selected from the group consisting of a carbon steel, a carbon steel alloy, and a mild steel.

11. The method of claim 9, wherein the metal article is part of a casing, a pipe, a pump, a screen, a valve, or a fitting of an oil or gas well.

12. The method of claim 9, wherein the acid is at least one selected from the group consisting of hydrochloric acid (HCl), sulfuric acid (H₂SO₄), nitric acid (HNO₃), phosphoric acid (H₃PO₄), acetic acid, and hydrofluoric acid (HF).

13. The method of claim 9, wherein the metal article has a metal corrosion rate of about 0.916 millimeter penetration per year (mmpy) when the NHc composite is present in the corrosive medium in an amount of about 100 ppm based on a total number of parts of the corrosive medium.

14. The method of claim 9, having an inhibition efficiency of about 95.44% when the NHc composite is present in the corrosive medium in an amount of about 100 ppm based on a total number of parts of the corrosive medium.

15. The method of claim 9, further comprising preparing the NHc composite by:
mixing and refluxing chitosan, an aromatic aldehyde, and water in the presence of acetic acid to form the chitosan Schiff base in the form of a precipitate;
mixing the chitosan Schiff base, the acetic acid and water to form a mixture; and
dropwise adding a dispersion containing the plurality of AgNP₃ to the mixture and mixing.

16. The method of claim 15, wherein the aromatic aldehyde is P-tolualdehyde.

17. The method of claim 15, wherein a molar ratio of the chitosan to the aromatic aldehyde present in the mixture is about 1:1 to 1:20.

18. The method of claim 15, wherein the chitosan Schiff base is present in the mixture at a concentration of 0.002 grams per milliliter (g/ml) to 0.02 g/ml based a total volume of the mixture.

19. The method of claim 15, wherein the AgNP₃ are present in the dispersion at a concentration of 0.005 milligrams per milliliter (mg/ml) to 0.05 mg/ml based a total volume of the dispersion.
